(19) United States
(12) Patent Application Publication
(10) Pub. No.: US 2025/0021029 A1
(43) Pub. Date: Jan. 16, 2025

(54) TONER, TONER CARTRIDGE, IMAGE FORMING APPARATUS, AND PRINTED ARTICLE

(71) Applicant: MITSUBISHI CHEMICAL CORPORATION, Tokyo (JP)

(72) Inventors: Daichi TATSUMI, Tokyo (JP); Shiho SANO, Tokyo (JP); Yuki NARUKAWA, Tokyo (JP)

(73) Assignee: MITSUBISHI CHEMICAL CORPORATION, Tokyo (JP)

(21) Appl. No.: 18/898,505

(22) Filed: Sep. 26, 2024

Related U.S. Application Data
(63) Continuation of application No. PCT/JP2023/012858, filed on Mar. 29, 2023.

(30) Foreign Application Priority Data
Mar. 30, 2022 (JP) 2022-055334

(51) Int. Cl. G03G 9/087; G03G 9/093

(52) U.S. Cl. CPC G03G 9/08755; G03G 9/08711; G03G 9/09328; G03G 9/09364; G03G 2215/0604

(57) ABSTRACT

A toner comprising at least a binder resin,
the binder resin including at least a polyester resin,
wherein a content of the polyester resin is 2.5% by mass or more of a total mass of the toner, and
when a total length of a portion of a cross section of a printed article produced by fixing the toner to a PET coated paper sheet under printing conditions including a printing temperature of 175° C., a printing speed of 16 ppm, and a printing density of 0.8 mg/cm², the portion in which the polyester resin is in contact with the PET coated paper sheet, is defined as A, and a total length of a portion of the cross section, the portion in which the toner is in contact with the PET coated paper sheet, is defined as B, A and B satisfy Formula (1) below.

$$0.05 \leq A / B \leq 0 \text{.55} \qquad ( 1 )$$

### TECHNICAL FIELD

The present invention relates to a toner excellent in terms of adhesiveness to printing media, low-temperature fixability, and storage stability, a toner cartridge and an image forming apparatus that include the toner, and a printed article produced using the toner.

### BACKGROUND ART

Electrostatic-image developing toners have been used in image forming apparatuses, such as a printer, a copying machine, and a facsimile machine, for forming images by visualization of electrostatic images. For example, when an image is formed using an electrophotographic system, first, an electrostatic latent image is formed on a photosensitive drum. The electrostatic latent image is developed using a toner, and the developed image is transferred to a printing medium, such as a transfer paper sheet. The toner is fixed thereto by heating to form an image.

An electrostatic-image developing toner is commonly constituted by toner base particles including a binder resin, a coloring agent, a wax, and the like and solid fine particles serving as an external additive, such as silica particles, which are deposited on the surfaces of the toner base particles. The binder resin included in the toner base particles is commonly a styrene acrylic resin.

Such a toner is required to have excellent adhesiveness to printing media, such as a paper sheet. In particular, there has been a growing tendency to use PET coated paper as a printing medium in order to increase the variety of printed articles and enhance the graphical design function, quality appearance, and durability of printed articles. Therefore, the toner is required to have excellent adhesiveness to PET coated paper.

When an image is formed on a printing medium, the toner is heated in order to fix the toner to the printing medium. Since the electric power used for the heating occupies a large part of the electric power consumed by an image forming apparatus, such as a copying machine, the toner is required to have a property of being fixed at further low temperatures (low-temperature fixability).

An electrostatic latent image developing toner has been proposed (PTL 1) as a toner having improved transferability, low-temperature fixability, and heat-resistant storability. The electrostatic latent image developing toner includes toner matrix particles having a core-shell structure and an external additive. The toner matrix particles each have a core particle including a vinyl-based resin and a shell that covers the surface of the core particle at a coverage of 60% to 99%. The shell includes an amorphous polyester resin. The external additive includes crosslinked vinyl-based resin particles. The number-average particle size of the crosslinked vinyl-based resin particles is 30 to 300 nm.

### CITATION LIST

### Patent Literature

PTL 1: JP2017-156543A

### SUMMARY OF INVENTION

### Technical Problem

The toners known in the related art, the toner base particles of which include a styrene acrylic resin as a binder resin, do not have sufficient degrees of adhesiveness to printing media, that is, in particular, PET coated paper. It is considered that the above issue occurs because styrene acrylic resins are incompatible with PET coated paper as materials. In addition, since styrene acrylic resins are hard and brittle, the adhesiveness between toner particles and a printing medium at the interface therebetween is poor.

Since the toner base particles disclosed in PTL 1 has a core-shell structure constituted by a shell composed of an amorphous polyester resin and core particles covered with the shell, the adhesiveness of the toner base particles to printing media can be improved to a certain degree. However, the above toner base particles still have the following disadvantages.

Specifically, the coverage with the shell is excessively high and, consequently, a large amount of amorphous polyester resin, which is relatively expensive, is used. This increases the costs.

Moreover, since the hydrophilicity of the surfaces is enhanced, the toner particles are likely to absorb moisture. This degrades storage stability, that is, in particular, storage stability under high-humidity conditions, and environmental stability.

Accordingly, an object of the present invention is to provide a toner that has suitable adhesiveness to printing media, that also has suitable adhesiveness to PET coated paper, that is excellent in terms of low-temperature fixability and storage stability, and that can be produced at relatively low costs, a toner cartridge and an image forming apparatus that include the toner, and a printed article produced using the toner.

### Solution to Problem

The inventor of the present invention found that the above object can be achieved when a predetermined amount of polyester resin is used as a binder resin constituting the toner and the ratio of the total length A of portions in which a printing medium which is in contact with the polyester resin to the total length B of portions in which a printing medium which is in contact with the toner, that is, a ratio A/B, which is determined using a specific method, is adjusted to fall within a predetermined range.

The gist of the present invention is as follows.

[1] A toner comprising at least a binder resin,
the binder resin including at least a polyester resin,
wherein a content of the polyester resin is 2.5% by mass or more of a total mass of the toner, and
when a total length of a portion of a cross section of a printed article produced by fixing the toner to a PET coated paper sheet under printing conditions including a printing temperature of 175° C., a printing speed of 16 ppm, and a printing density of 0.8 mg/cm², the portion in which the polyester resin is in contact with the PET coated paper sheet, is defined as A, and a total length of a portion of the cross section, the portion in which the toner is in contact with the PET coated paper sheet, is defined as B, A and B satisfy Formula (1) below.

$$0.05 \leq A / B \leq 0 \text{.55} \qquad ( 1 )$$

[2] The toner according to [1], wherein the binder resin further includes a styrene acrylic resin.
[3] The toner according to [1] or [2], wherein the polyester resin is an amorphous polyester resin.
[4] The toner according to any one of [1] to [3], wherein the content of the polyester resin is 2.5% by mass or more and 40% by mass or less of the total mass of the toner.
[5] The toner according to any one of [1] to [4], further comprising a wax.
[6] The toner according to [5], wherein a content of the wax is 5% by mass or more and 30% by mass or less of the total mass of the toner.
[7] The toner according to [5] or [6], wherein the wax is a crystalline wax.
[8] The toner according to [7], wherein, in differential scanning calorimetry (DSC) that implements a temperature program including increasing temperature from 40° C. to 100° C. or more at a heating rate of 10° C./min (first temperature rise), subsequently reducing temperature to 40° C. or less at a cooling rate of 10° C./min (first temperature drop), and then increasing temperature to 100° C. or more at a heating rate of 10° C./min (second temperature rise), a difference between a half-width of an endothermic peak that occurs during the first temperature drop and a half-width of an exothermic peak that occurs during the first temperature rise [(first temperature drop)−(first temperature rise)] is 7.0° C. or less, and a difference between the half-width of the endothermic peak that occurs during the first temperature drop and a half-width of an exothermic peak that occurs during the second temperature rise [(first temperature drop)−(second temperature rise)] is 7.0° C. or less.
[9] The toner according to any one of [1] to [8], wherein the polyester resin has an acid value of 5 mgKOH/g or more.
[10] The toner according to any one of [1] to [9], wherein the polyester resin has a glass transition temperature (Tg) of 50° C. or more and 70° C. or less.
[11] The toner according to any one of [1] to [10], the toner having a structure constituted by a core and a shell, wherein a binder resin included in the core is the styrene acrylic resin, and a binder resin included in the shell is the polyester resin.
[12] The toner according to any one of [1] to [11], the toner having a volume-median particle size of 6.5 μm or less, wherein a proportion of particles having a primary particle size of 1.0 μm or less is 3.0% or less by number.
[13] The toner according to any one of [1] to [12], further comprising a coloring agent.
[14] A toner cartridge comprising the toner according to any one of [1] to [13].
[15] An image forming apparatus comprising the toner according to any one of [1] to [13].
[16] A printed article comprising a printing medium and a toner fixed on the printing medium,
the toner being a toner including at least a binder resin,
the binder resin including at least a polyester resin,
wherein a content of the polyester resin is 2.5% by mass or more of a total mass of the toner, and
when a total length of a portion of a cross section of a printed article produced by fixing the toner to a PET coated paper sheet under printing conditions including a printing temperature of 175° C., a printing speed of 16 ppm, and a printing density of 0.8 mg/cm², the portion in which the polyester resin is in contact with the PET coated paper sheet, is defined as A, and a total length of a portion of the cross section, the portion in which the toner is in contact with the PET coated paper sheet, is defined as B, A and B satisfy Formula (1) below.

$$0.05 \leq A / B \leq 0 \text{.55} \qquad ( 1 )$$

[17] The printed article according to [16], wherein the binder resin further includes a styrene acrylic resin.

### Advantageous Effects of Invention

According to the present invention, a toner that has suitable adhesiveness to printing media, that also has suitable adhesiveness to PET coated paper, and that is excellent in terms of low-temperature fixability and storage stability, a toner cartridge and an image forming apparatus that include the toner, and a printed article produced using the toner can be provided.

### BRIEF DESCRIPTION OF DRAWINGS

FIG. 1 is a cross-sectional SEM image of a fixed image formed in Example 1 using a toner C1.

### DESCRIPTION OF EMBODIMENTS

Embodiments in which the present invention is implemented (hereinafter, also referred to as “embodiments of the present invention”) are described in detail below. It should be noted that the present invention is not limited by the embodiments below and various modifications may be made within the scope of the present invention.

In the present description, when a range is expressed as “x to y” (where x and y represent a number), the expression means “preferably more than x” or “preferably less than y” in addition to “equal to or more than x and equal to or less than y” unless otherwise specified.

When a range is expressed as “equal to or more than x” (where x is a number) or “equal to or less than y” (where y is a number), the expression also means that “preferably more than x” or “preferably less than y”.

### [Toner]

A toner according to an embodiment of the present invention (hereinafter, referred to as “present toner”) is a toner including at least a binder resin, the binder resin including at least a polyester resin, wherein a content of the polyester resin is 2.5% by mass or more of a total mass of the toner, and when a total length of a portion of a cross section of a printed article produced by fixing the toner to a PET coated paper sheet under printing conditions including a printing temperature of 175° C., a printing speed of 16 ppm (paper per minutes), and a printing density of 0.8 mg/cm², the portion in which the polyester resin is in contact with the PET coated paper sheet, is defined as A, and a total length of a portion of the cross section, the portion in which the toner is in contact with the PET coated paper sheet, is defined as B, the ratio A/B of A to B (hereinafter, referred to as “A/B ratio”) satisfies Formula (1) below.

$$0.05 \leq A / B \leq 0 \text{.55} \qquad ( 1 )$$

The present toner includes a binder resin, and the binder resin includes at least a polyester resin. The binder resin preferably includes a styrene acrylic resin. The present toner is preferably a toner including toner base particles (referred to as “present toner base particles”) and an external additive, the toner base particles further including, as needed, a coloring agent, a charge-controlling agent, or another component.

Note that the structure of the present toner is not necessarily limited to the above. For example, the toner does not necessarily include a coloring agent (clear toner) and does not necessarily include a charge-controlling agent or an external additive.

### <A/B Ratio>

The A/B ratio of the present toner satisfies Formula (1) above.

The A/B ratio satisfying Formula (1) above means that the polyester resin is present in the surfaces of particles of the present toner in an adequate amount. This also means that the present toner preferably has a core-shell structure, the binder resin included in the core is preferably a styrene acrylic resin, and the binder resin included in the shell is a polyester resin.

Since the present toner has an A/B ratio of 0.05 or more, the present toner can have suitable adhesiveness to printing media as a result of the polyester resin being present in the surfaces of the toner particles. In particular, the adhesiveness of the toner to PET coated paper and the strength at which the toner adheres to PET coated paper can be markedly enhanced since the polyester resin, which has the same ester structure as PET, is present in the surfaces of the toner particles.

The presence of the polyester resin in the surfaces of the toner particles also increases the stickiness between the polyester resin particles that are in contact with one another at the interface between the toner particles due to the hydrogen bond property, etc. thereof. This also results in an increase in adhesion strength.

On the other hand, since the amount of polyester resin is relatively small such that the A/B ratio is 0.55 or less, the present toner has suitable storage stability. This also limits increases in costs which may occur in the case where relatively expensive polyester resins are used.

The A/B ratio can be determined in the following manner.

The toner is fixed to a PET coated paper sheet under the following printing conditions: printing temperature: 175° C., printing speed: 16 ppm (paper per minutes), printing density: 0.8 mg/cm² in order to prepare a printed article. Then, a cross section of the PET coated paper sheet is observed with a backscattered electron detector of a scanning electron microscope (SEM) at a 10,000-fold magnification.

The above observation steps are repeated for each of sufficient numbers of fields of view in order to obtain observation images. It is considered sufficient when the numbers of fields of view is 30 or more. In Examples below, the above observation was made for each of 40 fields of view.

For each of the images, the length of portions of the image in which the polyester resin included in the toner surface is in contact with the surface of the printing medium is measured, and the total (A) of the above lengths is calculated. Subsequently, the length of portions of the image in which the toner is in contact with the surface of the printing medium is measured, and the total (B) of the above lengths is calculated. The total (A) of the above lengths is divided by the total (B) to obtain the value (A/B).

Note that, in the measurement of the above length, when some of the toner particles are detached from the fixed surface in the observed cross section, they are considered as being in contact with the fixed surface.

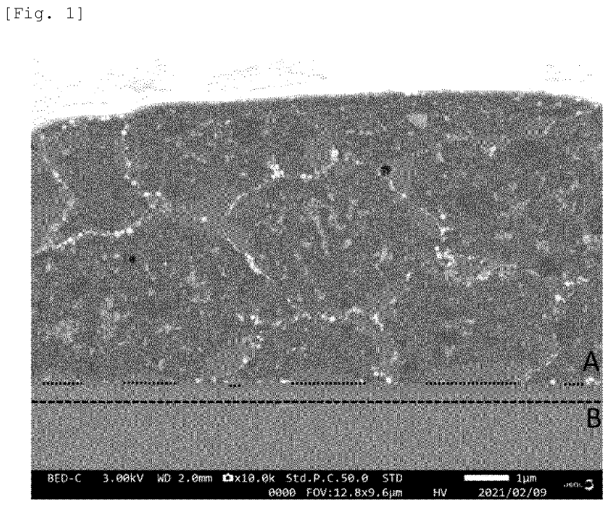

Further details of the (A) and (B) are described below with reference to FIG. 1. As illustrated in FIG. 1, in a SEM image, the components of the toner appear in different shades due to atomic number, density gap, or edge effect. In FIG. 1, the continuous layer indicates a styrene acrylic resin. A low-shade portion of the discontinuous layer which is located at the outer interface of the toner particles indicates a polyester resin. The high-shade portion which is present inside the toner particles indicates a wax. The low-shade portions finely dispersed inside the toner particles indicate a coloring agent. The fine, particulate low-shade portions which are present in the outermost portion of the toner indicate an external additive composed of an inorganic substance.

In FIG. 1, the portion denoted with the dotted line is the “portions in which the polyester resin included in the toner surface is in contact with the surface of the printing medium (PET coated paper sheet)”, and the total length of the portions denoted with the dotted line is the (A).

In FIG. 1, the total length of the portion denoted with the broken line is the total length of the “portions in which the toner is in contact with the surface of the printing medium (PET coated paper sheet)”, that is, the (B).

The toner illustrated in FIG. 1 is a toner having a core-shell structure, which includes a core component that is a styrene acrylic resin and a shell component that is a polyester resin.

In the present invention, the term “core-shell structure” refers to a structure constituted by a core component and a shell component that covers the surface of the core component. In the core-shell structure, the shell component does not necessarily cover the entirety of the core component; the surface of the core component may be partially exposed, that is, the shell component may have a discontinuous structure, as illustrated in FIG. 1.

The A/B ratio determined in the above-described manner can be considered as the area fraction of the polyester resin that is included in the toner surface and is in contact with the surface of the PET coated paper sheet, that is, the abundance ratio of the polyester resin in the surface of the present toner, from the following viewpoint.

It is considered that, in the printed article to which the toner is fixed, the fixed toner particles are randomly oriented. Therefore, it is possible to consider that, even when a cross section of the printed article which is taken in only one direction is observed, observing the cross section taken in only one direction in a sufficient number of fields of view is equivalent to observing the cross section in a sufficient number of directions at a sufficient number of positions because the directions in which the toner particles are aligned (the orientations of the toner particles) and the positions of the toner particles are different from one another. Thus, the sum of the sufficient number of lengths obtained in the respective fields of view can be considered as an area calculated using integration. Consequently, the above ratio can be considered as an area fraction as described above.

Although further detailed steps are described in Examples below, the methods and devices are not limited to those described below. It is possible to use a cross-section preparation method and a microscope observation method with which results appropriate to the object can be achieved.

The A/B ratio of the present toner is preferably 0.05 or more, is more preferably 0.10 or more, is further preferably 0.20 or more, and is particularly preferably 0.30 or more in consideration of improvement of adhesiveness and fixability to printing media and storage stability. The above A/B ratio is preferably 0.55 or less, is more preferably 0.50 or less, is further preferably 0.45 or less, and is particularly preferably 0.40 or less.

In order to allow the present toner to satisfy the above A/B ratio, it is preferable that the present toner have a core-shell structure constituted by a core including a styrene acrylic resin as a binder resin and a shell including a polyester resin as a binder resin and that the amount of the polyester resin constituting the shell be adjusted to fall within an adequate range.

### <Ratio (X/Y) of Calculated Coverage X to Measured Coverage Y of Toner Surface With Polyester Resin>

The ratio (X/Y) of the calculated coverage X of the surface of the present toner to the measured coverage Y of the surface of the present toner is preferably 1.5 or more. The above ratio (X/Y) is more preferably 2.0 or more, is further preferably 2.25 or more, is further preferably 2.5 or more, and is particularly preferably 3.0 or more. The above ratio is preferably 20.0 or less, is more preferably 10.0 or less, is further preferably 5.0 or less, and is particularly preferably 3.9 or less.

The higher the above ratio, the larger the thickness of the polyester resin layer. When the above thickness is adjusted to fall within an adequate range, the toner has suitable adhesiveness to printing media. Note that the term “polyester resin layer” means that the polyester resin is unevenly distributed in the toner surface, and the polyester resin layer may be in the form of fine particles or a thin-film. The above layer may cover the toner surface in a continuous or discontinuous manner. In the present invention, the above layer preferably covers the toner surface in a discontinuous manner in order to satisfy the above A/B ratio.

The calculated coverage X and measured coverage Y of the toner surface with the polyester resin can be determined using the following methods.

### <Method for Calculating Calculated Coverage X of Toner Surface With Polyester Resin>

The coverage of the surfaces of the toner particles with the polyester resin particles when the polyester resin particles are dispersed on the surfaces of the toner particles one by one in a homogeneous manner is defined as “theoretical coverage”. The theoretical coverage is synonymous with the calculated coverage X.

An example case where the toner base particles have a core-shell structure, the core includes a styrene acrylic resin as a binder resin, and the shell includes a polyester resin as a binder resin is described below.

The coverage of the surfaces of the core particles with the shell particles when the shell particles are dispersed on the surfaces of the core particles one by one in a homogeneous manner is defined as “theoretical coverage”. The theoretical coverage is synonymous with the calculated coverage X below.

The calculated coverage X is defined as Formula (2) below. Note that it is assumed that the core particles and the shell particles be spherical.

$$( 2 )$$

$$X = \{ ( Number of shell particles per core particle ) \times ( Projected area of one shell particle ) \} / Surface area of one core particle$$

### (Method for Calculating Number of Shell Particles per Core Particle)

When the mass ratio of the core is defined as “A”, the mass ratio of the shell can be expressed as “(1-A)”. The above values can be calculated on the basis of the charging ratios.

The mass of one core particle and the mass of one shell particle can be calculated in the following manner.

$${\{ ( π / 6 ) \times ( Diameter of particle ) \}}^{3} \times Specific gravity$$

For example, the specific gravity is assumed to be 1.0 for the styrene acrylic resin and 1.1 for the polyester resin in the calculation.

The mass of one core particle and the mass of one shell particle are defined as S and s, respectively. Furthermore, the numbers of the core particles and the shell particles are defined as K and k, respectively. When S×K=A, s×k=(1−A).

Thus, (Number of shell particles per core particle) can be expressed as follows.

(Number of shell particles per core particle)=k/K

Specifically, when A, S, and s are known values, (Number of shell particles per core particle) can be calculated using the above formula.

### (Method for Measuring Projected Area of One Shell Particle and Surface Area of One Core Particle)

When the shell particles are assumed to be spherical, the area occupied by a shell particle on the surface of a core particle can be determined as the projected area of the shell particle viewed from directly above. The projected area of a sphere viewed from directly above is synonymous with the area of a two-dimensional circle having the same diameter as the sphere. Thus, the projected area of a shell particle can be calculated using Formula (3) below.

$$( Projected area of shell particle ) = {\{ ( Diameter of shell particle ) / 2 \}}^{2} \times π \qquad ( 3 )$$

When the core particles are assumed to be spherical, the surface area of a core particle can be calculated using Formula (4) below in accordance with the formula for the surface area of a sphere.

$$( 4 )$$

$$( Surface area of core particle ) = 4 \times {\{ ( Diameter of core particle ) / 2 \}}^{2} \times π$$

The number of the shell particles per core particle, the projected area of a shell particles, and the surface area of a core particle are determined in the above-described manner and substituted into Formula (2) to obtain the calculated coverage X, that is, the theoretical coverage.

### <Method for Determining Measured Coverage Y of Toner Surface With Polyester Resin>

The method for determining the measured coverage Y may be performed using any procedure. For example, the A/B ratio described above can be used as a measured coverage Y.

The measured coverage Y may alternatively be determined by staining the toner particles with ruthenium, observing the stained toner particles with a scanning electron microscope, and analyzing the resulting image. The likelihood of a resin being stained with ruthenium varies by the type of the resin; for example, the rates at which a polyester resin and a styrene acrylic resin are stained with ruthenium are significantly different from each other. Therefore, in the backscattered electron image of the surfaces of the toner particles, a difference between brightness occurs between the surface formed of a polyester resin and the surface formed of a styrene acrylic resin. This enables the surface formed of a polyester resin and the surface formed of a styrene acrylic resin to be identified.

### <Average Thickness of Polyester Resin in Toner Surface>

The average thickness of the polyester resin in the surface of the present toner is preferably 0.20 μm or more. In particular, the above average thickness is more preferably 0.23 μm or more, is further preferably 0.25 μm or more, is particularly preferably 0.28 μm or more, and is most preferably 0.30 μm or more. The average thickness is preferably 0.70 μm or less, is more preferably 0.55 μm or less, is further preferably 0.40 μm or less, and is particularly preferably 0.35 μm or less.

The average thickness of the polyester resin in the toner surface can be determined by the following method.

### <Method for Determining Average Thickness of Polyester Resin in Toner Surface>

The method for determining the average thickness of the polyester resin in the toner surface may be performed by any means. The above average thickness can be determined by, for example, directly measuring a cross-sectional SEM image of the above-described printed article. It is considered sufficient that the number of fields of view be 30 or more. In Examples below, the observation was made in 40 fields of view.

It is also possible to calculate the above average thickness by computation on the basis of the ratio (X/Y) of the calculated coverage X to the measured coverage Y of the toner surface with the polyester resin, which is described above. In the case where the polyester resin is adhered to the toner surface in the form of single particles without aggregation, it is considered that the average thickness of the polyester resin is equal to the average particle size of a latex of the polyester resin. The above (X/Y) is considered to indicate the deviation from the theoretical value. Thus, the above average thickness can be calculated using Formula (5) below.

$$( Average thickness of polyester resin in toner surface ) = ( Average particle size of latex of polyester resin ) \times ( X / Y ) \qquad ( 5 )$$

### <Difference in Half-Width of Exothermic Peak>

The present toner preferably includes the wax described below and particularly preferably includes a crystalline wax such that, in differential scanning calorimetry (DSC) that implements a temperature program including increasing temperature from 40° C. to 100° C. or more, that is, for example, 40° C. to 130° C., at a heating rate of 10° C./min (first temperature rise), subsequently reducing temperature to 40° C. or less at a cooling rate of 10° C./min (first temperature drop), and then increasing temperature to 100° C. or more, that is, for example, 40° C. to 130° C., at a heating rate of 10° C./min (second temperature rise), a difference between a half-width of an endothermic peak that occurs during the first temperature drop and a half-width of an exothermic peak that occurs during the first temperature rise [(first temperature drop)−(first temperature rise)] is 7.0° C. or less, and a difference between the half-width of the endothermic peak that occurs during the first temperature drop and a half-width of an exothermic peak that occurs during the second temperature rise [(first temperature drop)−(second temperature rise)] is 7.0° C. or less.

A difference between the half-width of an endothermic peak that occurs during temperature drop and the half-width of an exothermic peak that occurs during temperature rise indicates the degree of the sharp melt property of the wax included in the toner. Note that the term “sharp melt” used herein refers to a phenomenon in which the wax included in the toner changes from a solid state to a liquid state in a short period of time when the temperature reaches its melting temperature. Upon being heated, the wax included in the toner changes from a solid state to a liquid state and migrates to the toner surface to produce an effect of a release agent. Accordingly, for achieving low-temperature fixability, the wax included in the toner is required to have a property with which the entirety of the wax can change to a liquid state within a considerably short period of time (about 1 second) it takes for the toner to pass through a fuser of an image forming apparatus, that is, a high sharp melt property. The endothermic and exothermic peaks of a wax which occur during temperature rise and temperature drop, respectively, become sharp when the wax has a high sharp melt property, that is, when the wax is capable of changing from a solid state to a liquid state instantaneously. Consequently, the difference between the half-width of an endothermic peak that occurs during temperature drop and the half-width of an exothermic peak that occurs during temperature rise becomes small.

For the above reasons, in the present toner, the difference between the half-width of the endothermic peak that occurs during the first temperature drop and the half-width of the exothermic peak that occurs during the second temperature rise [(First temperature drop)−(Second temperature rise)] is preferably 7.0° C. or less. It is more preferable that the difference between the half-width of the endothermic peak that occurs during the first temperature drop and the half-width of the exothermic peak that occurs during the first temperature rise [(First temperature drop)−(First temperature rise)] be also 7.0° C. or less. In other words, it is preferable that both “difference between the half-width of the endothermic peak that occurs during the first temperature drop and the half-width of the exothermic peak that occurs during the first temperature rise [(First temperature drop)−(First temperature rise)]” and “difference between the half-width of the endothermic peak that occurs during the first temperature drop and the half-width of the exothermic peak that occurs during the second temperature rise [(First temperature drop)−(Second temperature rise)]” be 7.0° C. or less, and it is more preferable that both of the above differences be 3.6° C. or less. That is, it is preferable that the sharp melt properties of the wax included in the present toner during the first temperature rise and the second temperature rise be at high levels comparable to each other.

When the difference between the half-width of the endothermic peak that occurs during the first temperature drop and the half-width of the exothermic peak that occurs during the first temperature rise [(First temperature drop)−(First temperature rise)] is 7.0° C. or less, the wax has a sufficiently high sharp melt property and the toner has excellent low-temperature fixability.

Accordingly, in the present toner, the above difference in half-width is preferably 7.0° C. or less, is more preferably 6.0° C. or less, is further preferably 5.0° C. or less, is particularly preferably 3.0° C. or less, and is most preferably 1.5° C. or less.

When the difference between the half-width of the endothermic peak that occurs during the first temperature drop and the half-width of the exothermic peak that occurs during the second temperature rise [(First temperature drop)−(Second temperature rise)] is 7.0° C. or less, the wax has sufficiently high crystallinity and the toner has excellent storage stability.

Accordingly, in the present toner, the above difference in half-width is preferably 7.0° C. or less, is more preferably 6.0° C. or less, is further preferably 5.0° C. or less, is particularly preferably 3.0° C. or less, and is most preferably 1.5° C. or less.

In the case where, in differential scanning calorimetry (DSC), a peak does not converge (the slope of the peak still continues) at the end of at least one of 40° C. or 100° C., the following procedure is done.

An endothermic or exothermic peak is identified on the basis of the base line taking the range of less than 40° C. or more than 100° C. into consideration, and the half-width of the peak is employed. In other words, the temperatures from which the half-width is calculated may include the range of less than 40° C. or more than 100° C.

Specific means for producing the present toner that satisfy the above-described physical properties is not limited. In particular, as described below, the above object can be achieved in a further suitable manner by selecting the compound used as a wax, by optimizing the content thereof and, in the case where a plurality of waxes are used in combination, by changing the combination thereof, the blending ratio thereof, or the like. In the case where the wax is a mixture or includes impurities, by-products, or the like, the above object can also be achieved depending on, for example, the purity thereof.

The above object can be suitably achieved depending on the combination of a binder resin, which is described below, and the wax.

In the present invention, when differential scanning calorimetry (DSC) of a toner is performed, all of the first temperature rise, first temperature drop, and second temperature rise need to be performed at a rate of 10° C./min as described above. Specifically, the above rate is desirably 10.0° C./min. The allowable range of the rate is 10.0±0.5° C./min.

The amount of endothermic energy, the amount of exothermic energy, and half-widths of endothermic and exothermic peaks all depend on the heating or cooling rate. Therefore, for example, the value measured with a rate of 5° C./min or 15° C./min greatly differ from the value measured with a rate of 10° C./min.

### <Base Particles of Present Toner>

The base particles of the present toner may be either a single-layer structure or a multilayer structure (core-shell structure) including a core and an outer layer (also referred to as “shell”) and preferably has a core-shell structure in order to satisfy the A/B ratio described above. The binder resin included in the core is preferably a styrene acrylic resin. The binder resin included in the shell is preferably a polyester resin. It is more preferable that the binder resin included in the core be a styrene acrylic resin and the binder resin included in the shell be a polyester resin.

In the present invention, the term “core-shell structure” refers to a structure including a core component and a shell component that covers the surface of the core component. Note that the core-shell structure is not limited to a structure in which the core component is completely covered with the shell component; the surface of the core component may be partially exposed, and a part of the core component may be dispersed in the shell component.

In any of the methods for preparing the base particles of the toner which are described below, the term “shell component” refers to a component that is unevenly distributed in the surface of the base particles of the toner. The shell component included in the toner may be in the form of either fine particles or a thin-film. The shell component may cover the core component in a continuous or discontinuous manner. In the present invention, it is preferable that the shell component cover the core component in a discontinuous manner in order to satisfy the above A/B ratio.

In the case where the base particles of the toner are prepared in an aqueous and/or a wet-process medium including an organic solvent as a continuous phase, a method of adding a core component and shell fine particles simultaneously to thermodynamically arrange the shell fine particles at the interface between the core component and the wet-process medium (method in which polarity is controlled) and a method of adding shell fine particles subsequent to the addition of a core component to physically arrange the shell fine particles on the surface of the core component. Note that the method of thermodynamically arranging the shell fine particles at the interface between the core component and the wet-process medium (method in which polarity is controlled) and the method of adding shell fine particles subsequent to the addition of a core component to physically arrange the shell fine particles on the surface of the core component can be used in combination with each other.

In the case where shell fine particles are added subsequent to the addition of a core component, alternatively, the further addition may be performed after the composition and/or shape of the core component have been determined (the shape, physical properties, compatibility, and the like of the core component may vary depending on the subsequent steps, such as heating, aging, and stirring).

In the case where the base particles of the present toner are multilayer structures each including a core and a shell, the core preferably includes a binder resin and, as needed, a coloring agent and a wax. The core further preferably includes a charge-controlling agent and other components. Although it is preferable that the shell include only the binder resin, the shell may include a coloring agent and a wax as needed and may further include a charge-controlling agent and other components.

As described above, it is preferable that the base particles of the present toner have a core-shell structure, the binder resin included in the core be a styrene acrylic resin, and the binder resin included in the shell be a polyester resin. In order to achieve such a structure, for example, the toner may have the following composition.

1) The content of the styrene acrylic segment in the polyester resin included in the shell is equal to or less than a predetermined value.

2) The content of the polyester segment in the styrene acrylic resin included in the core is equal to or less than a predetermined value.

3) The ratio of the acid value of the styrene acrylic resin included in the core to the acid value of the polyester resin included in the shell ([Acid value of styrene acrylic resin included in core]/[Acid value of polyester resin included in shell]) is 0.85 or more and 2.9 or less.

In the case of 1) above, the content of the styrene acrylic segment in the polyester resin included in the shell is preferably 20 parts by mass or less, is more preferably 10 parts by mass or less, and is further preferably 5 parts by mass or less relative to 100 parts by mass of the polyester resin. It is particularly preferable that the above content be 0 part by mass, that is, the polyester resin included in the shell do not include a styrene acrylic segment. In other words, the polyester resin included in the shell is not a styrene acryl-modified polyester resin.

In the case of 2) above, the content of the polyester segment in the styrene acrylic resin included in the core is preferably 20 parts by mass or less, is more preferably 10 parts by mass or less, and is further preferably 5 parts by mass or less relative to 100 parts by mass of the styrene acrylic resin. It is particularly preferable that the above content be 0 part by mass, that is, the styrene acrylic resin included in the core do not include a polyester segment.

Examples of the method for polymerizing the polyester segment with the styrene acrylic resin include, but are not limited to, the following methods.

2-1) A method of causing the polyester polymerization segment to react with a bireactive monomer, which is subsequently reacted with a styrene acryl raw material monomer.

2-2) A method of causing the styrene acrylic resin to react with a bireactive monomer, which is then reacted with a polyvalent carboxylic acid monomer and a polyhydric alcohol monomer.

2-3) A method of causing the styrene acrylic resin and the polyester resin to react with a bireactive monomer, which are then chemically bonded to each other.

In the case of 3) above, the lower limit for the ratio of the acid value of the styrene acrylic resin included in the core to the acid value of the polyester resin included in the shell ([Acid value of styrene acrylic resin included in core]/[Acid value of polyester resin included in shell]) is more preferably 0.90 or more and is further preferably 1.0 or more. The upper limit for the above ratio is more preferably 2.5 or less and is further preferably 2.0 or less. When the above ratio is equal to or more than the above lower limit, the shell has higher hydrophilicity than the core and, consequently, the shell is unlikely to enter the inside of the toner particles during the aging step. When the above ratio is equal to or less than the above upper limit, the hydrophilicity of the shell is not increased excessively and a dispersion liquid of the polyester resin can be stabilized to an adequate degree accordingly. This enables the formation of an appropriate core-shell structure.

In the case where the base particles of the present toner have a core-shell structure, the storage modulus (G′ (70° C.) of the binder resin included in the shell which is measured with a rheometer at 70° C. (hereinafter, this storage modulus may be referred to simply as “G′ (70° C.)”) is preferably 500000 Pa or more.

When the G′ (70° C.) of the binder resin included in the shell is 500000 Pa or more, further high storage stability can be achieved. The G′ (70° C.) of the binder resin included in the shell is more preferably 700000 Pa or more and is further preferably 1000000 a or more in consideration of storage stability. The G′ (70° C.) of the binder resin included in the shell is preferably 5000000 Pa or less and is more preferably 3000000 Pa or less in consideration of low-temperature fixability.

In the case where the base particles of the present toner have a core-shell structure, the storage modulus (G′ (100° C.) of the binder resin included in the shell which is measured with a rheometer at 100° C. (hereinafter, this storage modulus may be referred to simply as “G′ (100° C.)”) is preferably 5000 Pa or less.

When the G′ (100° C.) of the binder resin included in the shell is 5000 Pa or less, further high low-temperature fixability can be achieved. The G′ (100° C.) of the binder resin included in the shell is more preferably 3000 Pa or less and is further preferably 2000 Pa or less in consideration of low-temperature fixability. The G′ (100° C.) of the binder resin included in the shell is preferably 500 Pa or more and is more preferably 1000 Pa or more in consideration of storage stability.

As described above, in the present invention, the binder resin included in the shell is preferably composed of a polyester resin. That is, the polyester resin constituting the shell preferably satisfies the G′ (70° C.) and G′ (100° C.) above.

In the present invention, examples of the method for producing a binder resin having the opposing physical properties, that is, G′ (70° C.) and G′ (100° C.), include a method of using a polyester resin that satisfies the G′ (70° C.) and G′ (100° C.) alone as a binder resin included in the shell; and a method of using a polyester resin that satisfies only the G′ (70° C.) above and a polyester resin that satisfies only the G′ (100° C.) above in a mixture as a binder resin included in the shell such that the G′ (70° C.) and G′ (100° C.) of the mixed polyester resin satisfy the above conditions.

The G′ (70° C.) and G′ (100° C.) of a binder resin can be determined by measuring dynamic viscoelasticity.

In the measurement of dynamic viscoelasticity, for example, a solid component prepared by vacuum-drying the polyester dispersion liquid can be used as a sample.

In the measurement of dynamic viscoelasticity, for example, a rheometer “ARES” produced by TA Instruments can be used as a device.

Specific examples of the measuring method include the following steps.

About 1.3 g of the sample is charged into a jig for 25-mm diameter. With a pressing machine heated to 50° C., the sample is pressed into a pellet at a load of 30 kg for 10 minutes. The pellet is charged into a measuring device equipped with circular parallel plates having a diameter of 25 mm. After the temperature has been increased to 120° C., the upper plate is lowered to adjust the thickness of the pellet to be 3.0 to 3.5 mm.

Subsequently, the temperature is reduced and the measurement is conducted under the following conditions: frequency: 6.28 rad/sec, initial temperature: 40° C., latency: 3 minutes, automatic tension control (tensile direction, initial force: 0, automatic tension sensitivity: 2.0 g, modulus of elasticity for automatic tension switchover: 1.0E+08 Pa), final temperature: 150° C., heating rate: 4° C./min, cycle time: 1 minute, initial strain: 0.1%, automatic strain control.

### <Styrene Acrylic Resin>

The styrene acrylic resin (hereinafter, may be abbreviated as “StAc”) is a copolymer produced using a styrene-based monomer and a (meth)acrylic acid ester-based monomer. The above copolymer is preferably a copolymer produced using a (meth)acrylic acid-based monomer in addition to the styrene-based monomer and the (meth)acrylic acid ester-based monomer.

Examples of styrene-based monomer include styrene, o-methylstyrene, m-methylstyrene, p-methylstyrene, p-methoxystyrene, p-phenylstyrene, o-chlorostyrene, m-chlorostyrene, p-chlorostyrene, p-ethylstyrene, p-n-butylstyrene, p-tert-butylstyrene, p-n-hexylstyrene, p-n-octylstyrene, p-n-nonylstyrene, p-n-decylstyrene, p-n-dodecylstyrene, 2,4-dimethylstyrene, dichlorostyrene, and the like. These can be used alone or in combination of two or more.

Among these, from the viewpoints of reactivity, ease of polymerization, and cost, styrene and p-methylstyrene are preferred, and styrene is more preferred.

Examples of (meth)acrylic acid ester-based monomer include methyl acrylate, ethyl acrylate, propyl acrylate, n-butyl acrylate, isobutyl acrylate, hydroxyethyl acrylate, 2-ethylhexyl acrylate, hexyl acrylate, cyclohexyl acrylate, heptyl acrylate, phenyl acrylate, methyl methacrylate, ethyl methacrylate, propyl methacrylate, n-butyl methacrylate, isobutyl methacrylate, hydroxyethyl methacrylate, hexyl methacrylate, cyclohexyl methacrylate, 2-ethylhexyl methacrylate, heptyl methacrylate, ethyl β-hydroxyacrylate, propyl γ-aminoacrylate, stearyl methacrylate, dimethylaminoethyl methacrylate, diethylaminoethyl methacrylate, and the like. These can be used alone or in combination of two or more.

Among these, from the viewpoints of toner fixability, non-offset property, and cost, propyl acrylate, n-butyl acrylate, isobutyl acrylate, and 2-ethylhexyl acrylate are preferred, n-butyl acrylate, and 2-ethylhexyl acrylate are more preferred, and n-butyl acrylate is even more preferred.

Examples of (meth)acrylic acid-based monomer include acrylic acid, methacrylic acid, maleic acid, fumaric acid, cinnamic acid, and the like. These can be used alone or in combination of two or more.

Among these, from the viewpoints of reactivity and ease of polymerization, acrylic acid and methacrylic acid are preferred, and acrylic acid is more preferred.

The proportion of the styrene-based monomer to 100% by mass of all the monomers constituting the styrene acrylic resin is preferably 50% by mass or more, is more preferably 60% by mass or more, and is further preferably 65% by mass or more in consideration of the storage stability of the toner. The above proportion is preferably 90% by mass or less, is more preferably 85% by mass or less, and is further preferably 80% by mass or less in consideration of the fixability of the toner.

The proportion of the (meth)acrylic acid ester-based monomer to 100% by mass of all the monomers constituting the styrene acrylic resin is preferably 10% by mass or more, is more preferably 15% by mass or more, and is further preferably 20% by mass or more in consideration of the fixability of the toner. The above proportion is preferably 50% by mass or less, is more preferably 40% by mass or less, and is further preferably 35% by mass or less in consideration of the storage stability of the toner.

The proportion of the (meth)acrylic acid-based monomer to 100% by mass of all the monomers constituting the styrene acrylic resin is preferably 0.3% by mass or more, is more preferably 0.5% by mass or more, and is further preferably 0.7% by mass or more in consideration of the developing property of the toner. The above proportion is preferably 3.0% by mass or less, is more preferably 2.5% by mass or less, and is further preferably 2.0% by mass or less in consideration of the environmental stability of the toner.

The ratio of the content of the (meth)acrylic acid ester-based monomer to the content of the styrene-based monomer, which constitute the styrene acrylic resin, is preferably 0.18 or more and is more preferably 0.25 or more; and is preferably 0.67 or less and is more preferably 0.54 or less. In particular, when the above ratio falls within a range of 0.49 or more and 0.54 or less, excellent low-temperature fixability can be achieved while storage stability is maintained at a level high enough for actual use.

The ratio between the contents of the styrene-based monomer and the (meth)acrylic acid-based monomer that constitute the styrene acrylic resin is such that the proportion of the (meth)acrylic acid-based monomer to the styrene-based monomer is preferably 0.005 or more and is more preferably 0.006 or more; and is preferably 0.035 or less and is more preferably 0.030 or less.

Furthermore, the styrene acrylic resin can also be made into a crosslinked structure by using other polyfunctional monomers. Examples of other polyfunctional monomer include hexanediol diacrylate, divinylbenzene, ethylene glycol dimethacrylate, ethylene glycol diacrylate, diethylene glycol dimethacrylate, diethylene glycol diacrylate, triethylene glycol dimethacrylate, triethylene glycol diacrylate, neopentyl glycol dimethacrylate, neopentyl glycol diacrylate, and the like. Among them, hexanediol diacrylate is preferred.

The polystyrene-equivalent mass-average molecular weight (Mw) of the styrene acrylic resin which is determined by gel permeation chromatography (GPC) is preferably 30000 to 150000.

When the mass-average molecular weight (Mw) of the styrene acrylic resin is 30000 or more, sufficient heat-resistant storability can be achieved. When the mass-average molecular weight (Mw) of the styrene acrylic resin is 150000 or less, sufficient low-temperature fixability can be achieved.

The method for determining the mass-average molecular weight (Mw) of the styrene acrylic resin is as described in Examples below.

Only one styrene acrylic resin may be used alone. Alternatively, two or more types of styrene acrylic resins which have different monomer compositions, different physical properties, or the like may be used in combination.

The content of the styrene acrylic resin in the present toner is preferably 60% to 85% by mass and is more preferably 65% to 80% by mass of the total mass (100% by mass) of the present toner in consideration of reductions in the costs of the toner and the environmental stability, fixability, and storage stability of the toner. When the content of the styrene acrylic resin is equal to or more than the above lower limit, large cost advantages are achieved. In addition, environmental stability and storage stability under high-humidity conditions can be maintained. When the content of the styrene acrylic resin is equal to or less than the above upper limit, the content of the polyester resin in the surface is maintained at a sufficient level. This advantageously enhances adhesiveness to media.

### <Polyester Resin>

The polyester resin used as a binder resin for the present toner (hereinafter, may be abbreviated as “PES”) is preferably an amorphous polyester resin in consideration of fixability, storage stability, and adhesiveness to media.

An amorphous polyester resin is a polyester resin that exhibits non-crystallinity such that the endothermic curve of the polyester resin determined by differential scanning calorimetry (DSC) has a glass transition point (Tg) but does not have a melting point, that is, a distinctive endothermic peak during temperature rise.

An amorphous polyester resin can be produced by conducting a polycondensation reaction using a polyvalent carboxylic acid monomer (derivative) and a polyhydric alcohol monomer (derivative) as raw materials in the presence of an appropriate polymerization catalyst. As the polyvalent carboxylic acid monomer derivative, for example, alkyl esters, acid anhydrides, and acid chlorides of polyvalent carboxylic acid monomers can be used. As polyhydric alcohol monomer derivatives, for example, esters of polyhydric alcohol monomers and hydroxycarboxylic acids can be used.

Examples of polyvalent carboxylic acid monomer include divalent acids such as oxalic acid, succinic acid, maleic acid, adipic acid, β-methyladipic acid, azelaic acid, sebacic acid, nonanedicarboxylic acid, decanedicarboxylic acid, undecanedicarboxylic acid, dodecanedicarboxylic acid, fumaric acid, citraconic acid, diglycolic acid, cyclohexane-3,5-diene-1,2-dicarboxylic acid, malic acid, citric acid, hexahydroterephthalic acid, malonic acid, pimelic acid, tartaric acid, mucilage acid, phthalic acid, isophthalic acid, terephthalic acid, tetrachlorophthalic acid, chlorophthalic acid, nitrophthalic acid, p-carboxyphenylacetic acid, p-phenylene diacetic acid, m-phenylene diglycolic acid, p-phenylene diglycolic acid, o-phenylene diglycolic acid, diphenylacetic acid, diphenyl-p, p′-dicarboxylic acid, naphthalene-1,4-dicarboxylic acid, naphthalene-1,5-dicarboxylic acid, naphthalene-2,6-dicarboxylic acid, anthracenedicarboxylic acid, dodecenylsuccinic acid, and the like; trivalent carboxylic acids such as trimellitic acid, pyromellitic acid, naphthalenetricarboxylic acid, naphthalenetetracarboxylic acid, pyrenetricarboxylic acid, pyrenetetracarboxylic acid, and the like. These can be used alone or in combination of two or more.

Among these, as divalent carboxylic acids, from the viewpoints of toner storage stability, handling properties, cost, and supply amount, maleic acid, adipic acid, fumaric acid, cyclohexane-3,5-diene-1,2-dicarboxylic acid, isophthalic acid, and terephthalic acid are preferred, adipic acid, isophthalic acid, and terephthalic acid are more preferred, and isophthalic acid and terephthalic acid are even more preferred.

As the trivalent carboxylic acid, from the viewpoint of ease of adjusting the polymerization rate, trimellitic acid and pyromellitic acid are preferred, and trimellitic acid is more preferred.

Examples of polyhydric alcohol monomer include dihydric alchols such as ethylene glycol, neopentyl glycol, propylene glycol, butanediol, diethylene glycol, hexanediol, cyclohexanediol, 1,2-cyclohexanedimethanol, 1,3-cyclohexanedimethanol, 1,4-cyclohexanedimethanol, octanediol, decanediol, dodecanediol, ethylene oxide adduct of bisphenol A, propylene oxide adduct of bisphenol A, and the like; trivalent or higher polyols such as glycerin, pentaerythritol, trimethylolpropane, hexamethylolmelamine, hexaethylrolmelamine, tetramethylolbenzoguanamine, tetraethylolbenzoguanamine, and the like. These can be used alone or in combination of two or more.

Among these, as the dihydric alcohols, from the viewpoints of reducing coloring property of the resin, ease of obtaining raw materials, and charging characteristics, ethylene glycol, neopentyl glycol, 1,4-cyclohexanedimethanol, ethylene oxide adducts of bisphenol A and propylene oxide adducts of bisphenol A are preferred, ethylene glycol, ethylene oxide adducts of bisphenol A, and propylene oxide adducts of bisphenol A are more preferred, and ethylene glycol and propylene oxide adducts of bisphenol A are even more preferred.

As the trivalent or higher polyols, from the viewpoint of ease of adjusting the polymerization rate, glycerin, pentaerythritol, and trimethylolpropane are preferred, and trimethylolpropane is more preferred.

The ratio between the polyvalent carboxylic acid and the polyhydric alcohol is preferably such that the equivalent ratio (OH)/(COOH) of the amount of hydroxyl groups (OH) included in the polyhydric alcohol to the amount of carboxyl groups (COOH) included in the polyvalent carboxylic acid is 1.5/1 to 1/1.5.

The acid value of the polyester resin is preferably 5 mgKOH/g or more.

When the acid value of the polyester resin is equal to or more than the above lower limit, the polyester resin has stability high enough to be used as a polyester dispersion liquid in the aggregation step of the preparation of the base particles of the toner. The acid value of the polyester resin is preferably 20 mgKOH/g or less in consideration of ease of preparation of particles having surfaces including the polyester.

The acid value of the polyester resin is more preferably 8 mgKOH/g or more and is further preferably 10 mgKOH/g or more; and is more preferably 18 mgKOH/g or less and is further preferably 15 mgKOH/g or less.

The acid value of the polyester resin is determined by the method described in Examples below.

The glass transition temperature (Tg) of the polyester resin is preferably 50° C. to 70° C. When the glass transition temperature of the polyester resin is equal to or more than the above lower limit, the storage stability of the toner can be maintained. When the glass transition temperature of the polyester resin is equal to or less than the above upper limit, the low-temperature fixability of the toner does not become degraded. Moreover, in the aging step of preparation of the base particles of the toner, the surfaces of the particles can be easily covered in a homogeneous manner. The glass transition temperature of the polyester resin is more preferably 53° C. or more and is further preferably 55° C. or more; and is more preferably 65° C. or less, is further preferably 63° C. or less, and is particularly preferably 60° C. or less.

The glass transition temperature of the polyester resin is determined by the method described in Examples below.

The softening temperature of the polyester resin is preferably within the range of 90 to 150° C. When the softening temperature of the polyester resin is equal to or higher than the above lower limit, the storage stability of the toner is maintained. When the softening temperature of the polyester resin is equal to or lower than the above upper limit, the low-temperature fixability of the toner will not deteriorate. The softening temperature of the polyester resin is more preferably 95° C. or higher, and even more preferably 100° C. or higher, and more preferably 135° C. or lower, even more preferably 125° C. or lower, and particularly preferably 115° C. or lower.

The softening temperature of the polyester resin is determined by the method described in Examples below.

The polyester resin preferably has a mass-average molecular weight (Mw) in terms of polystyrene measured by gel permeation chromatography (GPC) of 20,000 or more, more preferably 25,000 or more. On the other hand, the mass-average molecular weight (Mw) is preferably 150,000 or less, more preferably 100,000 or less, and even more preferably 80,000 or less.

The method for measuring the mass-average molecular weight (Mw) of the polyester resin is as described in Examples below.

The present toner may contain only one type of polyester resin, or may contain two or more types of polyester resins having different monomer compositions, physical properties, and the like.

The content of the polyester resin is 2.5% by mass or more of the total mass of the present toner. The above content is preferably 2.5% to 40% by mass in order to satisfy the A/B ratio described above. The proportion of the content of the polyester resin to the total mass of the present toner is more preferably 5% by mass or more and is further preferably 10% by mass or more; and is more preferably 30% by mass or less and is further preferably 20% by mass or less.

### <Coloring Agent>

The coloring agents known in the related art can be used as a coloring agent included in the present toner. Specific examples of the coloring agent include carbon black, aniline blue, phthalocyanine blue, phthalocyanine green, Hansa yellow, Rhodamine-based dyes and pigments, chrome yellow, quinacridone-based, benzidine yellow, rose bengal, a triarylmethane-based dye, and monoazo-based, disazo-based, and condensed azo-based dyes and pigments. Various dyes and pigments known in the related art can be used alone or in a mixture.

In the case where a full-color toner is to be produced, it is preferable to use monoazo-based, disazo-based, polyazo-based, and condensed azo-based dyes and pigments as a yellow toner; quinacridone-based and/or monoazo-based dyes and pigments as a magenta toner; phthalocyanine-based dyes and pigments as a cyan toner; and carbon black and the like as a black toner.

The combination of the toners is preferably a set of a magenta toner that is a quinacridone-based dye or pigment and/or a monoazo-based dye or pigment, a black toner that is carbon black, a cyan toner that is a copper phthalocyanine-based dye or pigment, and a yellow toner that is at least one dye or pigment selected from monoazo-based, disazo-based, and condensed azo-based dyes and pigments.

Specifically, examples of cyan toner include C. I. Pigment Blue 15:3, C. I. Pigment Blue 15:4, and the like. Examples of yellow toner include C. I. Pigment Yellow 74, C.I. Pigment Yellow 83 that is a disazo dye pigment, and C.I. Pigment Yellow 93, C. I. Pigment Yellow 155, C. I. Pigment Yellow 180, and C. I. Pigment Yellow 185 these are condensed azo dye pigments, and the like. Examples of magenta toner include C. I. Pigment Red 48:1, C.I. Pigment Red 53:1, C.I. Pigment Red 57:1, C.I. Pigment Red 5, C.I. Pigment Red 122, C. I. Pigment Red 209, and C.I. Pigment Red 209 these are quinacridone dye pigments, C.I. Pigment Red 269 (238) that is a monoazo dye pigment, and the like.

The amount of the coloring agent used is preferably 3% to 20% by mass of the total mass (100% by mass) of the present toner.

### <Wax>

The present toner may further include a wax. When the present toner includes a wax, low-temperature fixability and a high-temperature offset property can be enhanced. The wax may be included in the toner in any form. For example, the binder resin and the wax may be partially or entirely dissolved in each other. In another case, the wax may be included in a separated manner using the core as a domain. Alternatively, the wax may be included in a separated manner using the shell as a domain. In still another case, the wax may be present in the surfaces of the toner particles in a separated manner.

When the present toner includes a wax, that is, in particular, a crystalline wax, the wax can be melted instantaneously upon the toner being heated and fixability to printing media can be enhanced consequently. In addition, in the case where the wax is included in the toner while separated from the core using the core as a domain, the was does not plasticize the toner and, consequently, storage stability can also be maintained. In particular, in the case where the wax is a crystalline wax that has a distinct melting point compared with common waxes, compatibility with the binder resin becomes degraded and the wax and the binder resin included in the core become completely separated from each other. This reduces the likelihood of plasticization of the resin and enables storage stability to be maintained.

The type of the wax included in the present toner is not limited. In particular, the present toner preferably includes an ester-based wax and more preferably includes a crystalline wax, which is described below.

Examples of the ester-based wax include ester-based waxes having a long-chain aliphatic group, such as behenyl behenate, stearyl behenate, montanic acid ester, stearyl stearate, and erythritol tetrabehenate.

Among these, monoester waxes primarily including a C18 and/or C22 hydrocarbon are further preferable. In particular, behenyl behenate, stearyl behenate, behenyl stearate, and waxes primarily including the above compounds are particularly preferable in consideration of low dust and low-temperature fixing.

The number of carbon atoms per molecule of the ester-based wax is preferably 36 or more and is more preferably 40 or more in consideration of low dust. The number of carbon atoms per molecule of the ester-based wax is preferably 95 or less, is more preferably 60 or less, is further preferably 48 or less, and is particularly preferably 44 or less in consideration of low-temperature fixing.

The melting peak temperature (top of the endothermic peak that occurs during the second temperature rise in the DSC of the toner) of the crystalline wax, which is suitably used for the present toner, is preferably 90° C. or less, is more preferably 85° C. or less, and is further preferably 80° C. or less; and is preferably 50° C. or more, is more preferably 60° C. or more, and is further preferably 65° C. or more. If the peak temperature of the melting point of the wax is excessively low, blocking resistance may become degraded. If the peak temperature of the melting point of the wax is excessively high, low-temperature fixability and high-gloss property may become degraded.

The difference between the peak temperature of the melting point of the wax and the onset temperature of the wax (the temperature that corresponds to the point at which the base line before the endothermic peak of the second DSC of the toner intersects the tangent at the first inflection point before the endothermic peak) is preferably 15° C. or less and is more preferably 10° C. or less.

### (Other Waxes)

The present toner may include a wax other than the ester-based wax described above and may include the other wax in combination with the ester-based wax.

Examples of the other wax include olefin-based waxes, such as a low-molecular-weight polyethylene, a low-molecular-weight polypropylene, and a polyethylene copolymer; paraffin waxes; plant-based waxes, such as a hydrogenated castor oil and a carnauba wax; ketones having a long-chain alkyl group, such as distearyl ketone; silicone having an alkyl group; higher fatty acids, such as stearic acid; and higher fatty acid amides, such as oleamide and stearamide. Preferable examples thereof include a hydrocarbon-based wax, such as a paraffin wax or a Fischer-Tropsch wax; and a silicone-based wax.

### (Content of Wax)

The content of wax in the present toner is preferably 5% to 30% by mass and is more preferably 10% to 20% by mass of the total mass (100% by mass) of the present toner. The content of the wax for low-temperature fixing is preferably 30% by mass or more and is more preferably 40% by mass or more; and is preferably 80% by mass or less of the total content (100% by mass) of the wax.

### <Charge-Controlling Agent>

The present toner may optionally include a charge-controlling agent in order to enhance the charging characteristics of the toner.

The charge-controlling agents publicly known in the related art can be used. Specific examples of the charge-controlling agent which have a positively charging property include a nigrosine dye, an amino group-containing vinyl-based copolymer, a quaternary ammonium salt compound, and a polyamine resin. Specific examples of the charge-controlling agent which have a negatively charging property include metal-containing azo dyes including a metal, such as chromium, zinc, iron, cobalt, or aluminum; salts of salicylic acid or an alkylsalicylic acid with the above metals; and metal complexes.

The amount of the charge-controlling agent is preferably 0.1% to 25% by mass and is more preferably 1% to 15% by mass of the total mass (100% by mass) of the present toner.

The charge-controlling agent may be added to the inside of the base particles of the toner or may be deposited on the surfaces of the base particles of the toner.

### <External Additive>

The present toner commonly includes an external additive in order to enhance the flowability and charge control property of the toner. The external additive is commonly deposited on the surfaces of the base particles of the toner. The degree at which the external additive is buried in the base particles is not limited. Specifically, a part or the entirety of the external additive may be attached to the base particles so as to come into contact with the surfaces of the base particles at points or to be buried in the surfaces of the base particles. In another case, a part or the entirety of the external additive may be present on the surfaces of the base particles in a dispersed or aggregated manner.

The size of particles of the external additive is desirably such that the ratio of the size of particles of the external additive to the average size of the base particles of the toner, that is, (Size of particles of external additive)/(Average size of base particles of toner), is 0.1% to 5%.

The external additive can be appropriately selected from various inorganic or organic fine particles. Two or more types of external additives may be used in combination.

As the inorganic fine particles, various carbides such as silicon carbide, boron carbide, titanium carbide, zirconium carbide, hafnium carbide, vanadium carbide, tantalum carbide, niobium carbide, tungsten carbide, chromium carbide, molybdenum carbide, calcium carbide, and the like; various nitrides such as boron nitride, titanium nitride, zirconium nitride, and the like; various borides such as zirconium boride, and the like; various oxides such as titanium oxide, calcium oxide, magnesium oxide, zinc oxide, copper oxide, aluminum oxide, cerium oxide, silica, colloidal silica, and the like; various titanic acid compounds such as calcium titanate, magnesium titanate, strontium titanate, and the like; phosphoric acid compounds such as calcium phosphate, and the like; sulfides such as molybdenum disulfide, and the like; fluorides such as magnesium fluoride, carbon fluoride, and the like; various metallic soaps such as aluminum stearate, calcium stearate, zinc stearate, magnesium stearate, and the like; talc, bentonite, various carbon blacks, conductive carbon black, magnetite, ferrite, and the like can be used.

As the organic fine particles, fine particles such as styrene resin, acrylic resin, epoxy resin, melamine resin, and the like can be used. Charge stability can be improved by using fine particles containing fluorine atoms.

Among these external additives, silica, titanium oxide, alumina, zinc oxide, various carbon blacks, conductive carbon black, and the like are particularly preferably used.

The external additive may be prepared by performing a surface treatment, such as hydrophobization, of the surfaces of the above inorganic or organic fine particles using a treatment agent, such as a silane coupling agent (e.g., hexamethyldisilazane (HMDS) or dimethyldichlorosilane (DMDS)), a titanate-based coupling agent, a silicone oil treatment agent (e.g., a silicone oil, a dimethylsilicone oil, a modified silicone oil, or an amino-modified silicone oil), a silicone varnish, a fluorine-containing silane coupling agent, a fluorine-containing silicone oil, or a coupling agent having an amino group or a quaternary ammonium salt group. The above treatment agents may be used in combination of two or more.

The amount of the external additive added is preferably 1.0 parts by mass or more, is particularly preferably 1.5 parts by mass or more, is preferably 6.5 parts by mass or less, and is particularly preferably 5.5 parts by mass or less relative to 100 parts by mass of the base particles of the present toner.

In the present toner, conductive fine particles may be used as an external additive in consideration of charge control. Examples of the conductive fine particles include metal oxides, such as conductive titanium oxide, silica, and magnetite; the above metal oxides doped with a conductive substance; organic fine particles prepared by doping a polymer having a conjugated double bond, such as polyacetylene, polyphenyl acetylene, or poly-p-phenylene, with a conductive substance, such as a metal; and carbon materials, such as carbon black and graphite. Among the above conductive fine particles, conductive titanium oxide and conductive titanium oxide doped with a conductive substance are more preferable in order to impart conductivity without impairing the flowability of the toner.

The lower limit for the content of the conductive fine particles is preferably 0.05 parts by mass or more, is more preferably 0.1 parts by mass or more, and is particularly preferably 0.2 parts by mass or more relative to 100 parts by mass of the base particles of the present toner. The upper limit for the content of the conductive fine particles is preferably 3 parts by mass or less, is more preferably 2 parts by mass or less, and is particularly preferably 1 part by mass or less.

### <Shape of Present Toner>

The volume-median particle size of the present toner is preferably 6.5 μm or less, is particularly preferably 6.3 μm or less, and is further particularly preferably 6.0 μm or less in consideration of image reproducibility and toner consumption.

The volume-median particle size of the present toner is preferably 3.0 μm or more, is particularly preferably 4.0 μm or more, and is further particularly preferably 4.5 μm or more in consideration of environmental safety from dust particles.

In the present invention, the term “volume-median particle size (Dv50)” refers to the value determined by the method described in Examples below. The volume-median particle size (Dv50) is defined as a Dv50 determined by analyzing the toner particles finally produced in a manufacturing process which include the base particles of the toner and the external additive as needed.

The proportion of the number of particles having a primary particle size of 1.0 μm or less in the present toner is preferably 3.0% or less, is particularly preferably 2.0% or less, and is further particularly preferably 1.0% or less; and is more preferably 0.5% or less and is further preferably 0.3% or less, in order to form high-quality images in a consistent manner while reducing fogging, staining of blank portions, or the like.

The shape of the present toner is preferably such that the average circularity determined using a flow particles image analyzer FPIA-3000 (produced by Malvern) is 0.92 or more and 0.99 or less. The above average circularity is particularly preferably 0.95 or more and is further particularly preferably 0.96 or more.

The above proportion of the number of particles having a size of 1.0 μm or less and the above average circularity are determined by the method described in Examples below.

### [Method for Producing Toner]

The present toner can be produced by preparing the base particles of the present toner using a method publicly known in the related art and adding an external additive onto the surfaces of the base particles of the present toner as needed.

### <Method for Producing Base Particles of Present Toner>

For producing the base particles of the present toner, a method in which raw materials are each prepared in the form of particles smaller than the base particles of the toner, the raw material particles are mixed together and caused to aggregate with one another, and aging is subsequently performed to form base particles of the toner can be used. The base particles of the toner can be produced by, for example, mixing fine particles of a binder resin (primary particles of a polymer), coloring agent particles, and, as needed, a wax, a charge-controlling agent, and the like with one another, then performing aggregation and aging (thermal fusion bonding), and subsequently performing filtration cleaning and drying.

The fine particles of the binder resin (primary particle of a polymer) can be produced by preparing the binder resin using emulsion polymerization or any polymerization method (e.g., bulk polymerization, solution polymerization, or suspension polymerization) and mixing the binder resin with an aqueous medium to form an emulsion.

Since performing the aggregation of the particles by emulsification aggregation in an aqueous system makes it easy to control the circularity, etc. of the base particles that are to be formed finally, it is preferable to form the polymer primary particles of the styrene acrylic resin using emulsion polymerization in which an aqueous emulsion is formed. For the same reasons as above, the polymer primary particles of the polyester resin is preferably formed using the latter emulsification method in the form of an aqueous emulsion.

The above methods for producing the polymer primary particles can be used in either case where the polymer primary particles of the binder resin included in the core are prepared or the polymer primary particles of the binder resin included in the shell are prepared.

### (Method for Producing Primary Particles of Polymer: Emulsion Polymerization)

For example, polymer primary particles constituted by the raw material monomers of the styrene acrylic resin described above are produced by performing emulsion polymerization using the monomers and, as needed, an emulsifier, a polymerization initiator, and a chain-transfer agent.

The emulsifiers publicly known in the related art may be used. One or two or more emulsifiers selected from cationic, anionic, and nonionic surfactants can be used in combination. Among these, an anionic surfactant is preferable in consideration of ease of preparation of the particles, a cleaning property, and the treatment of waste fluids.

Examples of the cationic surfactant include dodecyl ammonium chloride, dodecyl ammonium bromide, dodecyl trimethyl ammonium bromide, dodecyl pyridinium chloride, dodecyl pyridinium bromide, hexadecyl trimethyl ammonium bromide, and the like.

Examples of the anionic surfactant include fatty acid soaps such as sodium stearate, sodium dodecanoate, and the like; sodium dodecyl sulfate, sodium dodecylbenzenesulfonate, sodium lauryl sulfate, and the like.

Examples of nonionic surfactants include polyoxyethylene dodecyl ether, polyoxyethylene hexadecyl ether, polyoxyethylene nonylphenyl ether, polyoxyethylene lauryl ether, polyoxyethylene sorbitan monooleate ether, monodecanoyl sucrose, and the like.

The amount of the emulsifier used is preferably 0.1 parts by mass or more and 10 parts by mass or less relative to 100 parts by mass of the raw material monomers. Increasing the amount of the emulsifier used results in a reduction in the size of the polymer primary particles. Reducing the amount of the emulsifier used results in an increase in the size of the polymer primary particles.

The above emulsifiers may be used in combination with one or two or more protective colloids selected from, for example, polyvinyl alcohols, such as partially or fully saponified polyvinyl alcohol; and cellulose derivatives, such as hydroxyethyl cellulose.

The polymerization initiators publicly known in the related art may be used alone or in combination of two or more. Examples of the polymerization initiators include persulfates, such as potassium persulfate, sodium persulfate, and ammonium persulfate; redox initiators that include the above persulfates as a component in combination with a reductant, such as acidic sodium sulfite; water-soluble polymerization initiators, such as hydrogen peroxide, 4,4′-azobiscyanovaleric acid, t-butyl hydroperoxide, and cumene hydroperoxide; redox initiators that include the above water-soluble polymerization initiators as a component in combination with a reductant, such as a ferrous salt; and benzoyl peroxide and 2,2′-azobis-isobutyronitrile. Among these, hydrogen peroxide is preferable in consideration of reactivity and costs. The above polymerization initiators may be added to the polymerization system at any timing, that is, before, upon, or after the addition of the monomers. The above addition methods may be combined with one another as needed.

The chain-transfer agents publicly known in the related art may be used alone or in combination of two or more. Examples of the chain-transfer agents include trichlorobromomethane, carbon tetrachloride, t-dodecyl mercaptan, and 2-mercaptoethanol. Among these, trichlorobromomethane is preferable in consideration of reduction in molecular weight, sharpening of molecular weight distribution, and the costs.

Among emulsion polymerization methods, seeded polymerization, in which a wax is used as a seed for emulsion polymerization, is preferably used. Seeded polymerization enables fine particles of the wax to be dispersed in the toner in a homogeneous manner and thereby limits the degradation of the charging property and heat resistance of the toner.

Alternatively, the wax and a long-chain monomer, such as stearyl acrylate, may be dispersed in an aqueous dispersion medium to prepare a wax/long-chain monomer dispersion liquid, and the monomers may be polymerized in the presence of the wax/long-chain monomer.

(Method for Producing Polymer Primary Particle: Method of Preparing Binder Resin Using Polymerization Method and Mixing the Binder Resin with Aqueous Medium to Form Emulsion)

A binder resin is prepared using a polymerization method, such as bulk polymerization, solution polymerization, or suspension polymerization. Subsequently, the binder resin is mixed with an aqueous medium, and a shear force is applied to the mixture to prepare an emulsion. Hereby, polymer primary particles of the binder resin can be formed.

Examples of the emulsifier used for the application of the shear force include a homogenizer, a homomixer, a pressure kneader, an extruder, and a medium disperser.

In the case where the size of the polymer primary particles cannot be reduced to an intended particle size when the viscosity of the binder resin is high during emulsification, polymer primary particles having the intended particle size can be prepared by increasing the temperature to a temperature equal to or more than the higher of the melting point and glass transition temperature of the resin using an emulsifier capable of increasing the pressure to a level higher than the atmospheric pressure and performing emulsification while the viscosity of the resin is reduced.

For reducing the viscosity of the resin, alternatively, an organic solvent may be mixed with the binder resin. The organic solvent may be any organic solvent in which the styrene acrylic resin is soluble. Examples of such organic solvents include ketone-based solvents, such as tetrahydrofuran (THF), methyl acetate, ethyl acetate, and methyl ethyl ketone; and benzene-based solvents, such as benzene, toluene, and xylene. In another case, in order to enhance affinity with aqueous media and control the particle size distribution, an alcohol-based solvent, such as ethanol or isopropyl alcohol, may be added to water or the resin. In the case where the organic solvent is used, the organic solvent needs to be removed from the emulsion subsequent to the termination of emulsification. For removing the organic solvent, for example, the organic solvent may be caused to volatilize at normal temperature or under heating while the pressure is reduced.

In order to control the particle size distribution, a salt, such as sodium chloride or potassium chloride, ammonia, or the like may be used. An emulsifier or a dispersing agent may also be used.

Examples of the above emulsifier and the above dispersing agent include water-soluble polymers, such as polyvinyl alcohol, methyl cellulose, carboxymethyl cellulose, and sodium polyacrylate; the above-described emulsifiers; and inorganic compounds, such as tricalcium phosphate, aluminum hydroxide, calcium sulfate, calcium carbonate, and barium carbonate. The amount of the emulsifier or dispersing agent used is preferably 0.01 to 20 parts by mass relative to 100 parts by mass of the binder resin.

Examples of the method of preparing a binder resin using a polymerization method and mixing the binder resin with an aqueous medium to form an emulsion further include, in addition to the above-described method, phase-inversion emulsification. Phase-inversion emulsification is a method in which an organic solvent, a neutralizer, and a dispersion stabilizer are added to the binder resin as needed, an aqueous medium is added dropwise to the resulting mixture, while stirring is performed, to form emulsified particles, and the organic solvent is removed from the resin dispersion liquid to prepare an emulsion. The organic solvent used above may be the same as the organic solvent described above. The neutralizer used above may be a common acid or alkali, such as nitric acid, hydrochloric acid, sodium hydroxide, or ammonia.

### (Size and Molecular Weight of Polymer Primary Particles)

The median diameter (D50) of the polymer primary particles of the binder resin is preferably 100 nm or more, is more preferably 150 nm or more, and is further preferably 180 nm or more; and is preferably 350 nm or less, is more preferably 300 nm or less, and is further preferably 280 nm or less.

The mass-average molecular weight (Mw) of the polymer primary particles of the binder resin is preferably 25000 or more, is particularly preferably 30000 or more, is more preferably 40000 or more, is further preferably 50000 or more, and is most preferably 70000 or more; is preferably 500000 or less, is more preferably 300000 or less, is further preferably 150000 or less, and is particularly preferably 100000 or less.

The median diameter (D50) and mass-average molecular weight (Mw) of the polymer primary particles of the binder resin are determined by the method described in Examples below.

### (Aggregation Step)

In the aggregation step, the polymer primary particles and, as needed, the coloring agent particles, the charge-controlling agent, the wax, etc. are mixed together simultaneously or successively. Prior to this step, dispersion liquids including the respective components, that is, a polymer primary particle dispersion and, as needed, a coloring agent particle dispersion liquid, a charge-controlling agent dispersion liquid, and a wax dispersion liquid, are prepared. It is preferable to mix the above dispersion liquids together to prepare a mixed dispersion liquid in consideration of the uniformity of the composition and the uniformity of particle size.

In the case where the base particles of the toner have a core-shell structure, the polymer primary particles of the binder resin included in the core and the polymer primary particles of the binder resin included in the shell may be charged simultaneously. Alternatively, after a part or all of the polymer primary particles of the binder resin included in the core have been aggregated with another component, the polymer primary particles of the binder resin included in the shell may be added.

In the case where the polymer primary particles (also referred to as “core component”) of the binder resin included in the core and the polymer primary particles (also referred to as “shell component”) of the binder resin included in the shell are charged simultaneously, the polarity of the shell component may be adjusted to be halfway between the polarities of the core component and the medium (e.g., water) thermodynamically. In such a case, the shell component can be deposited to the circumference of the core component spontaneously. In the case where the shell component is deposited in a wet-process medium, such as water and/or an organic solvent, it is preferable to add the shell component after the composition of the raw materials for the core component has been determined (in the case where the base particles of the toner are prepared by aggregation of particles smaller than the base particles of the toner, after a part or the entirety of the core component has been aggregated) in order to increase the likelihood of the shell component being arranged on the surface of the core component.

The addition of the shell component may be done in one batch or a plurality of batches. The shell component added for the first time and the shell component added from the second time onward may be different from each other, and the combination thereof is not limited. In order to enhance the stability of the aggregates of particles having a core-shell structure, which is formed in the aggregation step, it is preferable to perform fusion bonding of the inside of the aggregated particles in the aging step subsequent to the aggregation step.

The coloring agent particles are preferably used while dispersed in water in the presence of an emulsifier. The median diameter (D50) of the coloring agent particles is preferably 0.01 μm or more and is particularly preferably 0.05 μm or more; and is preferably 3 μm or less and is particularly preferably 1 μm or less. The median diameter of the coloring agent particles is determined by the method described in Examples below.

The wax is preferably used while dispersed in water. The median diameter (D50) of the wax is preferably 100 nm or more, is more preferably 150 nm or more, and is further preferably 200 nm or more; and is preferably 400 nm or less, is more preferably 350 nm or less, and is further preferably 300 nm or less. The median diameter of the wax is determined by the method described in Examples below.

In the aggregation step, aggregation is commonly performed in a tank equipped with a stirring device. Examples of the aggregation method include a method in which heating is performed to cause aggregation, a method in which an electrolyte is used to cause aggregation, and a method in which the above methods are used in combination.

When performing aggregation by adding an electrolyte, the electrolyte may be acid, alkali, or salt, and may be either organic or inorganic.

Specifically, examples of the electrolyte include acids such as hydrochloric acid, nitric acid, sulfuric acid, citric acid, and the like; alkalis such as sodium hydroxide, potassium hydroxide, aqueous ammonia, and the like; salts such as NaCl, KCl, LiCl, Na₂SO₄, K₂SO₄, Li₂SO₄, MgCl₂, CaCl₂, MgSO₄, CaSO₄, ZnSO₄, Al₂(SO₄)₃, Fe₂(SO₄)₃, CH3COONa, C6H5SO3Na, and the like. Among these, inorganic salts having a polyvalent metal cation of divalent or higher valence are preferred.

The amount of the electrolyte added, which varies depending on the type of the electrolyte, the intended particle size, and the like, is preferably 0.02 parts by mass or more and is more preferably 0.05 parts by mass or more; and is preferably 25 parts by mass or less, is more preferably 15 parts by mass or less, and is further preferably 10 parts by mass or less relative to 100 parts by mass of the solid component of the mixed dispersion liquid.

In the case where aggregation is performed by the addition of the electrolyte, the aggregation temperature is preferably 20° C. or more and is particularly preferably 30° C. or more; and is preferably 70° C. or less and is particularly preferably 60° C. or less.

The amount of time required by the aggregation is optimized by the shape of the device and the scale of the treatment. In order to allow the size of the base particles of the toner reaching the intended particle size, it is preferable to perform holding for at least 30 minutes or more at the above predetermined temperature. The temperature may be increased to the predetermined temperature at a constant rate or in a plurality of stages.

### (Aging Step)

In the aging step, the mixed dispersion liquid prepared in the aggregation step is heated under sufficient stirring conditions.

The temperature at which the aging step is conducted is, in the case where a core-shell structure is formed, preferably equal to or more than the Tg of the polymer primary particles of the binder resin included in the shell and is more preferably equal to or more than a temperature higher than the Tg of the polymer primary particles of the binder resin included in the shell by 5° C.

The amount of time required by the aging step, which varies by the intended shape of the base particles of the toner, is preferably such that holding is performed for 0.1 to 10 hours after the temperature has reached the temperature equal to or more than the Tg of the polymer primary particles of the binder resin included in the shell. It is more preferable to perform holding for 0.5 to 5 hours.

It is preferable to perform the addition of a surfactant, pH adjustment, or both of the above treatments at a timing subsequent to the aggregation step or preferably at a timing prior to the aging step or during the aging step. The surfactant used above may be one or more selected from the emulsifiers that can be used in the production of the polymer primary particles. In particular, the emulsifier is preferably the same as the emulsifier used for producing the polymer primary particles.

In the case where the surfactant is used, the amount of the surfactant added is, but not limited to, preferably 0.1 parts by mass or more and is more preferably 0.3 parts by mass or more; and is preferably 20 parts by mass or less, is more preferably 15 parts by mass or less, and is further preferably 10 parts by mass or less relative to 100 parts by mass of the solid component of the mixed dispersion liquid.

When the addition of the surfactant or pH adjustment is performed subsequent to the aggregation step and prior to the completion of the aging step, for example, the likelihood of the aggregates of the particles, which are prepared in the aggregation step, being aggregated with one another can be reduced. This may reduce the formation of coarse particles in the aging step.

The base particles of the toner having various shapes, such as a grape-like shape formed as a result of the shape of the aggregated polymer primary particles being maintained, a potato-like shape formed as a result of fusion bonding, and a spherical shape formed as a result of further fusion bonding, can be produced in accordance with the intended applications by controlling the amount of time during which the aging step is conducted.

### <Method for Adding External Additive Onto Surfaces>

Examples of the method for the addition of the external additive include a method in which a high-speed stirrer, such as a Henschel mixer, is used; and a method in which a device capable of applying a compressive shear stress is used.

The toner can be prepared by a single-stage addition method in which all the external additives are added onto the surfaces of the base particles of the toner at a time. The toner can also be prepared by a multi-stage addition method in which each of the external additives is added onto the surfaces one by one.

In order to prevent temperature rise during the addition of the external additive, for example, a cooling device may be placed in the container. Alternatively, the multi-stage addition may be conducted.

### [Type of Usage]

The present toner may be included in a two-component developer that includes a toner and a carrier or a magnetic or non-magnetic one-component developer that does not include a carrier.

In the case where the toner is included in the two-component developer, examples of the carrier include the carriers publicly known in the related art, such as magnetic substances (e.g., an iron powder, a magnetite powder, and a ferrite powder); carriers prepared by coating the surfaces of the above magnetic substances with a resin; and magnetic carriers. Examples of the resin included in the above resin-coated carriers include a styrene-based resin, an acrylic resin, a styrene acrylic copolymer-based resin, a silicone resin, a modified silicone resin, a fluororesin, and mixtures thereof, which are commonly known in the related art.

### [Cartridge and Image Forming Apparatus]

An image forming apparatus that includes the present toner (the image forming apparatus according to the present invention) according to an embodiment is described below. It should be noted that the embodiment is not limited by the following description and various modifications can be made without departing from the summary of the present invention.

The image forming apparatus includes an electrophotographic photosensitive member, a charging device, an exposure device, a developing device, and a toner and may optionally include a transfer device, a cleaning device, and a fixing device as needed.

The electrophotographic photosensitive member is not limited and may be, for example, a drum-like photosensitive member that includes a cylindrical conductive support and the above-described photosensitive layer disposed on the surface of the conductive support.

The charging device is used to charge the surface of the electrophotographic photosensitive member to a predetermined potential in a homogeneous manner. Examples of the common charging device include contactless corona charging devices, such as corotron and scorotron; and contact charging devices.

The exposure device may be any type of exposure device with which the electrophotographic photosensitive member can be exposed to light and an electrostatic latent image can be formed on the photosensitive surface of the electrophotographic photosensitive member.

The transfer device applies a predetermined voltage (transfer voltage) in a polarity opposite to that of the potential to which the toner is charged and thereby transfers a toner image formed on the electrophotographic photosensitive member to a recording paper (sheet or medium). The type of the transfer device is not limited. Transfer devices using various transfer methods, such as corona transfer and roller transfer, can be used.

The cleaning device scrapes off the retained toner particles adhered to the electrophotographic photosensitive member with a cleaning member and collects the retained toner. Note that the cleaning device is not necessarily be included in the case where the amount of toner that remains on the surface of the electrophotographic photosensitive member is small or negligible. The cleaning device is not limited; any cleaning device, such as a brush cleaner, a magnetic roller cleaner, or a blade cleaner, may be used.

In the image forming apparatus having the above-described structure, an image is recorded in the following manner.

The surface (photosensitive surface) of the electrophotographic photosensitive member is charged to a predetermined potential by the charging device. The above charging may be performed by using a direct current voltage or by superimposing an alternating voltage on a direct current voltage.

The charged photosensitive surface of the electrophotographic photosensitive member is exposed to light with the exposure device in accordance with the image that is to be recorded. Hereby, an electrostatic latent image is formed on the photosensitive surface. The electrostatic latent image formed on the photosensitive surface of the electrophotographic photosensitive member is developed with the developing device.

The developing device forms a toner into a thin layer with a regulatory member, such as a developing blade, while performing triboelectrification of the toner in a predetermined polarity, then transports the toner with developing rollers on which the toner is supported on, and brings the toner into contact with the surface of the electrophotographic photosensitive member.

When the charged toner supported on the developing rollers is brought into contact with the surface of the electrophotographic photosensitive member, a toner image that corresponds to the electrostatic latent image is formed on the photosensitive surface of the electrophotographic photosensitive member. The toner image is then transferred to a recording paper sheet or the like with the transfer device. The toner that has not transferred and remains on the photosensitive surface of the electrophotographic photosensitive member is removed with the cleaning device.

A final image can be formed by, after the toner image has been transferred to a printing medium, such as a recording paper sheet, passing the toner image through the fixing device to thermally fix the toner image to the printing medium, such as a recording paper sheet.

The image forming apparatus may further include, in addition to the above-described structure, for example, a structure with which an erasing step can be conducted. The erasing step is a step of exposing the electrophotographic photosensitive member to light to erase the electrophotographic photosensitive member.

Further modifications may be made to the image forming apparatus. For example, the image forming apparatus may be modified such that a pre-exposure step, an auxiliary charging step, or the like can be conducted or such that offset printing can be performed. The image forming apparatus may be a full-color tandem image forming apparatus that includes a plurality of types of toners.

A member that accommodates the toner may be combined with one or more selected from the charging device, the exposure device, the developing device, the transfer device, the cleaning device, and the fixing device to form an integral-type cartridge (hereinafter, referred to as “toner cartridge” as needed). This toner cartridge may be detachably attached to the main body of an image forming apparatus, such as a copying machine or a laser beam printer.

The present toner is applied to the above toner cartridge, which is the toner cartridge according to the present invention.

### [Printed Article]

A printed article (referred to as “present printed article”) according to an embodiment of the present invention is a printed article including a printing medium and a toner fixed on the printing medium, the toner including at least a binder resin, the binder resin including at least a polyester resin, wherein a content of the polyester resin is 3% by mass or more of a total mass of the toner, and when a total length of a portion of a cross section of a printed article produced by fixing the toner to a printing medium under printing conditions including a printing temperature of 175° C., a printing speed of 16 ppm, and a printing density of 0.8 mg/cm², the portion in which the polyester resin is in contact with the printing medium, is defined as A, and a total length of a portion of the cross section, the portion in which the toner is in contact with the printing medium, is defined as B, the ratio of A to B, that is, the A/B ratio, satisfies Formula (1) below.

$$0.05 \leq A / B \leq 0 \text{.55} \qquad ( 1 )$$

The present printed article can be produced by performing printing on a printing medium using the present toner in accordance with a conventional method.

Thus, the description of the elements of the present toner above can be applied to the toner included in the present printed article.

The printing medium included in the present printed article is not limited and may be any printing medium commonly used in image forming apparatuses, such as a common printing sheet (e.g., a cardboard, a postcard, an envelope, a plain paper sheet, or a thin paper sheet), a paper sheet coated with a resin (plastic), such as PET, or a metal, an OHP sheet, an OHP film, or a tracing paper. Since the present toner has particularly high adhesiveness to PET coated paper, the present toner is suitably applied to a printed article including PET coated paper.

### EXAMPLE

Hereinafter, the present invention will be explained in more detail with reference to Examples. The present invention is not limited to the following Examples unless it exceeds the gist thereof.

In the following Examples and Comparative Examples, “parts” means “parts by mass”.

The methods for determining the physical properties are as described below.

### <Median Diameters (D50) of Polymer Primary Particles, Wax, and Coloring Agent (Pigment)>

The median diameters (D50) of the polymer primary particles, the wax, and the coloring agent (pigment) were measured using Model: “Microtrac Nanotrac 150” produced by Nikkiso Co., Ltd. (hereinafter, referred to simply as “Nanotrac”) and analysis software “Microtrac Particle Analyzer Ver 10.1.2-0.19EE” produced by Nikkiso Co., Ltd.

The above measurement was conducted using ion-exchange water having an electric conductivity of 0.5 μS/cm as a solvent by the method described in the user's manual under the following conditions: solvent refractive index: 1.333, measurement time: 120 seconds, number of measurements: 5 times. Then, the average thereof was calculated. The other conditions were as follows: particle refractive index: 1.59, permeability: permeable, shape: spherical, density: 1.04.

### <Volume-Median Particle Size (Dv50) of Toner>

The volume-median particle size (Dv50) of the toner was measured using “Multisizer III” produced by Beckman Coulter, Inc. (aperture diameter: 100 μm or less, referred to simply as “Multisizer”). In the measurement, the toner was dispersed in a dispersion medium “ISOTON II” produced by Beckman Coulter, Inc. such that the concentration of the dispersoid was 0.03% by mass. The measurement results are referred to as “Volume particle size”.

### <Average Circularity and Proportion of Number of Particles Having Size of 1.0 μm or Less>

The average circularity and the proportion of the number of particles having a size of 1.0 μm or less were determined by dispersing the dispersoid in a dispersion medium (Cellsheath produced by Malvern) such that 5720 to 7140 particle/μL was achieved and subsequently performing an analysis using a flow particle analyzer (FPIA3000 produced by Malvern) in an HPF mode under the conditions of HPF analysis amount: 0.35 μL, HPF detection amount: 2000 to 2500 particles. The measurement results are referred to as “circularity” and “Percentage of particles of 1.0 μm or less by number”.

### <Mass-Average Molecular Weight (Mw)>

The mass-average molecular weight of the styrene acrylic resin was determined by freeze-drying the styrene acrylic dispersion liquid described below to remove moisture and analyzing the THF-soluble component by gel permeation chromatography (GPC) under the following conditions.

The mass-average molecular weight of the amorphous polyester resin was determined by analyzing an amorphous polyester resin prepared by the steps described below using gel permeation chromatography (GPC) under the following conditions.

Device: GPC equipment HLC-8320 produced by Tosoh Corporation

Column: TOSOH TSKgel SuperHM-H (diameter: 6 m×length: 150 mm×2)

Solvent: THE

Column temperature: 40° C.

Flow rate: 0.5 mL/min

Sample concentration: 0.1% by mass

Calibration curve: Standard polystyrene

### <Solid Concentration in Emulsion>

The solid concentration in an emulsion was determined by heating 2 g of the sample at 195° C. for 90 minutes using an infrared radiation moisture analyzer “FD-610” produced by Kett Electric Laboratory Co. Ltd. to remove moisture by evaporation.

### <Glass Transition Temperature (Tg)>

The glass transition temperature of the polyester resin was determined using a differential scanning calorimeter (“DSC-60” produced by Shimadzu Corporation) on the basis of the point at which a base line of a chart at a heating rate of 5° C./min intersects a tangent to an endothermic curve. The above measurement was conducted using a sample prepared by weighing 10 mg±0.5 mg of a sample in an aluminum pan, melting the sample at 100° C., which is equal to or more than the glass transition temperature, for 10 minutes, and subsequently rapidly cooling the sample with dry ice.

### <Softening Temperature (T4)>

The softening temperature of the polyester resin was determined by measuring the temperature at which ½ of 1.0 g of a resin sample was discharged using Flowtester (“CFT-500D” produced by Shimadzu Corporation) with a nozzle having a size of 1 mm diameter×10 mm at a load of 294 N while the temperature was constantly increased at a heating rate of 3° C./min. The above temperature was considered as a softening temperature.

### <Acid Value>

The acid value of the polyester resin was determined in the following manner.

About 0.2 g of the sample was precisely weighed (a (g)) in a branched Erlenmeyer flask. To the flask, 20 mL of benzyl alcohol was added. Subsequently, in a nitrogen atmosphere, heating was performed with a heater of 230° C. for 15 minutes in order to dissolve the sample. After the temperature had been reduced to room temperature by air cooling, 20 mL of chloroform and a few drops of a cresol red solution were added. Then, titration was performed with a 0.02N KOH solution (Amount of titration: b (mL), titer of KOH solution: p). A blank test was conducted in the same manner as described above (amount of titration: c (mL)). The acid value was calculated using the formula below.

$$Acid value ( mg KOH / g ) = \{ ( b - c ) \times 0.02 \times 56.11 \times p \} / a$$

The wax dispersion liquid, the coloring agent dispersion liquid, and the polymer primary particle dispersions (styrene acrylic dispersion liquid and polyester dispersion liquid) used in Examples and Comparative Examples are described below.

### <Wax Dispersion Liquid W1>

Into a CSTR stirred tank equipped with a 45-degree tilted three-blade paddle impeller, as a wax, 30 parts of an ester wax 1 (chemical formula: C₂₁H₄₃COOC₂₂H₄₅), 1.93 parts of a 20% aqueous solution of sodium dodecylbenzenesulfonate (hereinafter, referred to simply as “20% aqueous DBS solution”), and 68.7 parts of desalted water were charged. The resulting mixture was stirred in the stirred tank for 20 minutes while being heated at 90° C.

Subsequently, while the resulting dispersion liquid was heated at 90° C., circulation emulsification was performed with a valve homogenizer (Model: 15-M-8PA produced by Gaulin) at a pressure of 25 MPa. Subsequently, the particle size was measured with Nanotrac, and dispersion was performed until the median diameter (D50) reached 245 nm. Hereby, a wax dispersion liquid W1 (solid concentration in emulsion: 30.5%) was prepared.

### <Wax Dispersion Liquid W2>

A wax dispersion liquid W2 (solid concentration in emulsion: 30.5%) was prepared as in the preparation of W1 above, except that 30 parts of an ester wax 2 (stearyl behenate, melting point: 67° C.), 1.93 parts of a 20% aqueous DBS solution, and 68.7 parts of desalted water were used.

### <Wax Dispersion Liquid W3>

A wax dispersion liquid W3 (solid concentration in emulsion: 30.8%) was prepared as in the preparation of W1 above, except that 30 parts of an ester wax 3 (stearyl stearate, melting point: 60° C.), 1.93 parts of a 20% aqueous DBS solution, and 68.7 parts of desalted water were used.

### <Wax Dispersion Liquid W4>

A wax dispersion liquid W4 (solid concentration in emulsion: 30.2%) was prepared as in the preparation of W1 above, except that 30 parts of an ester wax 4 (Product name: WEP-3, produced by NOF CORPORATION, melting point: 73° C., acid value: 0.1 mgKOH/g, hydroxyl value: 3 mgKOH/g or less (the above are all catalog values)), 0.24 parts of decaglycerin decabehenate (Product name: B100D, produced by Mitsubishi Chemical Corporation, hydroxyl value: 27, melting point: 70° C.), 1.93 parts of a 20% aqueous DBS solution, and 67.83 parts of desalted water were used.

### <Wax Dispersion Liquid W5>

A wax dispersion liquid W5 (solid concentration in emulsion: 31.0%) was prepared as in the preparation of W1 above, except that 15.0 parts of the ester wax 1, 15.0 parts of the ester wax 4, 1.93 parts of a 20% aqueous DBS solution, and 68.7 parts of desalted water were used.

### <Wax Dispersion Liquid W6>

A wax dispersion liquid W6 (solid concentration in emulsion: 31.0%) was prepared as in the preparation of W1 above, except that 15 parts of the ester wax 4, 15.0 parts of an ester wax 5 (Product name: WEP-5, produced by NOF CORPORATION, melting point: 82° C., acid value: 0.1 mgKOH/g, hydroxyl value: 3 mgKOH/g or less (the above are all catalog values)), 1.93 parts of a 20% aqueous DBS solution, and 68.7 parts of desalted water were used.

### <Coloring Agent Dispersion Liquid G1>

To a container of a stirrer equipped with a propeller blade, as a coloring agent, 24 parts of Pigment Blue 15:3 (cyan pigment (copper phthalocyanine complex) produced by Dainichiseika Color & Chemicals Mfg. Co., Ltd.), 1 part of a 20% aqueous DBS solution, 9 parts of a nonionic surfactant (EMULGEN 120 produced by Kao Corporation), and 67 parts of ion-exchange water having an electric conductivity of 2 μS/cm were added. The resulting mixture was subjected to preliminary dispersion to form a pigment premix liquid. The premix liquid was fed to a wet-process bead mill as a raw material slurry to perform dispersion. The inside diameter of the stator of the wet-process bead mill was 120 mm. The diameter of the separator was 60 mm. The medium used for dispersion was zirconia beads having a diameter of 0.1 mm. Since the effective inner capacity of the stator was about 2 Liter and the volume of the medium charged was 1.4 Liter, the medium-filled ratio was 70%. While the rotation speed of the rotor was set to be constant (rotation speed of the rotor at the front end: about 11 m/sec), the raw material slurry was fed through the feed port at a feeding speed of about 40 Liter/hr with a nonpulsatile metering pump. The dispersion treatment was stopped when the predetermined particle size was achieved. Subsequently, a coloring agent dispersion liquid G1 was obtained from the discharge port.

The above operation was conducted while cooling water having a temperature of about 10° C. was circulated in the jacket. The median diameter (D50) of the coloring agent was 83 nm. The solid content in the dispersion liquid was 34.3%. The solid content in the coloring agent was 24.1%.

### <Styrene Acrylic Dispersion Liquid A1>

Into a reaction container equipped with a stirring device, a heating/cooling device, a concentrating device, and devices for charging raw materials and agents, 35.3 parts of the wax dispersion liquid W1, 258 parts of desalted water, and 0.02 parts of a 0.5% aqueous solution of iron (II) sulfate heptahydrate were charged. While the resulting mixture was stirred, the temperature was increased in a nitrogen stream such that the internal temperature reached 70° C.

Subsequently, while stirring was continued, a mixture of the following monomers and emulsifier solutions was added to the mixture over 300 minutes to prepare an aqueous solution of monomers and emulsifiers. In this step, the time at which the addition of the mixture was started was considered as the time at which polymerization was started, and the following aqueous solutions of initiators were added dropwise to the mixture for 420 minutes after a lapse of 30 minutes since the start of polymerization. Subsequently, after a lapse of 300 minutes since the start of polymerization, the temperature was increased such that the internal temperature reached 90° C. After a lapse of 330 minutes since the start of polymerization, the following aqueous solution of iron sulfate was added to the mixture. The heating and stirring were continued for 540 minutes since the start of polymerization.

### (Monomers)

Styrene: 70.0 parts
Butyl acrylate: 30.0 parts
Acrylic acid: 0.95 parts
Trichlorobromomethane: 1.0 parts
Hexanediol diacrylate: 0.60 parts

### (Aqueous Solution of Emulsifier)

20% aqueous DBS solution: 1.0 parts
Desalted water: 66.7 parts

### (Aqueous Solution of Initiator)

8% aqueous hydrogen peroxide solution: 15.5 parts
8% aqueous L-(+) ascorbic acid solution: 30.1 parts (Aqueous Solution of Iron Sulfate)
0.5% aqueous solution of iron (II) sulfate heptahydrate: 0.08 parts

After the polymerization reaction had been finished, cooling was performed. Hereby, a milky white styrene acrylic dispersion liquid A1 was prepared. The median diameter (D50) of the polymer primary particles determined using Nanotrac was 230 nm. The mass-average molecular weight (Mw) of the polymer primary particles was 81608.

### <Styrene Acrylic Dispersion Liquid A2>

Into a reaction container equipped with a stirring device, a heating/cooling device, a concentrating device, and devices for charging raw materials and agents, 70.7 parts of the wax dispersion liquid W1, 269 parts of desalted water, and 0.02 parts of a 0.5% aqueous solution of iron (II) sulfate heptahydrate were charged. While the resulting mixture was stirred, the temperature was increased in a nitrogen stream such that the internal temperature reached 70° C.

Subsequently, while stirring was continued, a mixture of the following monomers and emulsifier solutions was added to the mixture over 300 minutes to prepare an aqueous solution of monomers and emulsifiers. In this step, the time at which the addition of the mixture was started was considered as the time at which polymerization was started, and the following aqueous solutions of initiators were added dropwise to the mixture for 420 minutes after a lapse of 30 minutes since the start of polymerization. Subsequently, after a lapse of 300 minutes since the start of polymerization, the temperature was increased such that the internal temperature reached 90° C. After a lapse of 330 minutes since the start of polymerization, the following aqueous solution of iron sulfate was added to the mixture. The heating and stirring were continued for 540 minutes since the start of polymerization.

### (Monomers)

Styrene: 70.0 parts
Butyl acrylate: 30.0 parts
Acrylic acid: 0.95 parts
Trichlorobromomethane: 1.0 parts
Hexanediol diacrylate: 0.60 parts

### (Aqueous Solution of Emulsifier)

20% aqueous DBS solution: 1.0 parts
Desalted water: 66.7 parts

### (Aqueous Solution of Initiator)

8% aqueous hydrogen peroxide solution: 15.5 parts
8% aqueous L-(+) ascorbic acid solution: 30.1 parts (Aqueous Solution of Iron Sulfate)
0.5% aqueous solution of iron (II) sulfate heptahydrate: 0.08 parts

After the polymerization reaction had been finished, cooling was performed. Hereby, a milky white styrene acrylic dispersion liquid A2 was prepared. The median diameter (D50) of the polymer primary particles determined using Nanotrac was 234 nm. The mass-average molecular weight (Mw) of the polymer primary particles was 80056.

### <Styrene Acrylic Dispersion Liquid A3>

Into a reaction container equipped with a stirring device, a heating/cooling device, a concentrating device, and devices for charging raw materials and agents, 71.3 parts of the wax dispersion liquid W2, 271 parts of desalted water, and 0.02 parts of a 0.5% aqueous solution of iron (II) sulfate heptahydrate were charged. While the resulting mixture was stirred, the temperature was increased in a nitrogen stream such that the internal temperature reached 70° C.

Subsequently, while stirring was continued, a mixture of the following monomers and emulsifier solutions was added to the mixture over 300 minutes to prepare an aqueous solution of monomers and emulsifiers. In this step, the time at which the addition of the mixture was started was considered as the time at which polymerization was started, and the following aqueous solutions of initiators were added dropwise to the mixture for 420 minutes after a lapse of 30 minutes since the start of polymerization. Subsequently, after a lapse of 300 minutes since the start of polymerization, the temperature was increased such that the internal temperature reached 90° C. After a lapse of 330 minutes since the start of polymerization, the following aqueous solution of iron sulfate was added to the mixture. The heating and stirring were continued for 540 minutes since the start of polymerization.

### (Monomers)

Styrene: 70.0 parts
Butyl acrylate: 30.0 parts
Acrylic acid: 0.95 parts
Trichlorobromomethane: 1.0 parts
Hexanediol diacrylate: 0.60 parts

### (Aqueous Solution of Emulsifier)

20% aqueous DBS solution: 1.0 parts
Desalted water: 66.7 parts

### (Aqueous Solution of Initiator)

8% aqueous hydrogen peroxide solution: 15.5 parts
8% aqueous L-(+) ascorbic acid solution: 30.1 parts (Aqueous Solution of Iron Sulfate)
0.5% aqueous solution of iron (II) sulfate heptahydrate: 0.08 parts

After the polymerization reaction had been finished, cooling was performed. Hereby, a milky white styrene acrylic dispersion liquid A3 was prepared. The median diameter (D50) of the polymer primary particles determined using Nanotrac was 206 nm. The mass-average molecular weight (Mw) of the polymer primary particles was 83212.

### <Styrene Acrylic Dispersion Liquid A4>

Into a reaction container equipped with a stirring device, a heating/cooling device, a concentrating device, and devices for charging raw materials and agents, 70.6 parts of the wax dispersion liquid W3, 272 parts of desalted water, and 0.02 parts of a 0.5% aqueous solution of iron (II) sulfate heptahydrate were charged. While the resulting mixture was stirred, the temperature was increased in a nitrogen stream such that the internal temperature reached 70° C.

Subsequently, while stirring was continued, a mixture of the following monomers and emulsifier solutions was added to the mixture over 300 minutes to prepare an aqueous solution of monomers and emulsifiers. In this step, the time at which the addition of the mixture was started was considered as the time at which polymerization was started, and the following aqueous solutions of initiators were added dropwise to the mixture for 420 minutes after a lapse of 30 minutes since the start of polymerization. Subsequently, after a lapse of 300 minutes since the start of polymerization, the temperature was increased such that the internal temperature reached 90° C. After a lapse of 330 minutes since the start of polymerization, the following aqueous solution of iron sulfate was added to the mixture. The heating and stirring were continued for 540 minutes since the start of polymerization.

### (Monomers)

Styrene: 70.0 parts
Butyl acrylate: 30.0 parts
Acrylic acid: 0.95 parts
Trichlorobromomethane: 1.0 parts
Hexanediol diacrylate: 0.60 parts

### (Aqueous Solution of Emulsifier)

20% aqueous DBS solution: 1.0 parts
Desalted water: 66.7 parts

### (Aqueous Solution of Initiator)

8% aqueous hydrogen peroxide solution: 15.5 parts
8% aqueous L-(+) ascorbic acid solution: 30.1 parts (Aqueous Solution of Iron Sulfate)
0.5% aqueous solution of iron (II) sulfate heptahydrate: 0.08 parts

After the polymerization reaction had been finished, cooling was performed. Hereby, a milky white styrene acrylic dispersion liquid A4 was prepared. The median diameter (D50) of the polymer primary particles determined using Nanotrac was 220 nm. The mass-average molecular weight (Mw) of the polymer primary particles was 79851.

### <Styrene Acrylic Dispersion Liquid A5>

Into a reaction container equipped with a stirring device, a heating/cooling device, a concentrating device, and devices for charging raw materials and agents, 35.7 parts of the wax dispersion liquid W4, 257 parts of desalted water, and 0.02 parts of a 0.5% aqueous solution of iron (II) sulfate heptahydrate were charged. While the resulting mixture was stirred, the temperature was increased in a nitrogen stream such that the internal temperature reached 70° C.

Subsequently, while stirring was continued, a mixture of the following monomers and emulsifier solutions was added to the mixture over 300 minutes to prepare an aqueous solution of monomers and emulsifiers. In this step, the time at which the addition of the mixture was started was considered as the time at which polymerization was started, and the following aqueous solutions of initiators were added dropwise to the mixture for 420 minutes after a lapse of 30 minutes since the start of polymerization. Subsequently, after a lapse of 300 minutes since the start of polymerization, the temperature was increased such that the internal temperature reached 90° C. After a lapse of 330 minutes since the start of polymerization, the following aqueous solution of iron sulfate was added to the mixture. The heating and stirring were continued for 540 minutes since the start of polymerization.

### (Monomers)

Styrene: 70.0 parts
Butyl acrylate: 30.0 parts
Acrylic acid: 0.95 parts
Trichlorobromomethane: 1.0 parts
Hexanediol diacrylate: 0.60 parts

### (Aqueous Solution of Emulsifier)

20% aqueous DBS solution: 1.0 parts
Desalted water: 66.7 parts

### (Aqueous Solution of Initiator)

8% aqueous hydrogen peroxide solution: 15.5 parts
8% aqueous L-(+) ascorbic acid solution: 30.1 parts (Aqueous Solution of Iron Sulfate)
0.5% aqueous solution of iron (II) sulfate heptahydrate: 0.08 parts

After the polymerization reaction had been finished, cooling was performed. Hereby, a milky white styrene acrylic dispersion liquid A5 was prepared. The median diameter (D50) of the polymer primary particles determined using Nanotrac was 273 nm. The mass-average molecular weight (Mw) of the polymer primary particles was 79487.

### <Styrene Acrylic Dispersion Liquid A6>

Into a reaction container equipped with a stirring device, a heating/cooling device, a concentrating device, and devices for charging raw materials and agents, 34.8 parts of the wax dispersion liquid W5, 258 parts of desalted water, and 0.02 parts of a 0.5% aqueous solution of iron (II) sulfate heptahydrate were charged. While the resulting mixture was stirred, the temperature was increased in a nitrogen stream such that the internal temperature reached 70° C.

Subsequently, while stirring was continued, a mixture of the following monomers and emulsifier solutions was added to the mixture over 300 minutes to prepare an aqueous solution of monomers and emulsifiers. In this step, the time at which the addition of the mixture was started was considered as the time at which polymerization was started, and the following aqueous solutions of initiators were added dropwise to the mixture for 420 minutes after a lapse of 30 minutes since the start of polymerization. Subsequently, after a lapse of 300 minutes since the start of polymerization, the temperature was increased such that the internal temperature reached 90° C. After a lapse of 330 minutes since the start of polymerization, the following aqueous solution of iron sulfate was added to the mixture. The heating and stirring were continued for 540 minutes since the start of polymerization.

### (Monomers)

Styrene: 70.0 parts
Butyl acrylate: 30.0 parts
Acrylic acid: 0.95 parts
Trichlorobromomethane: 1.0 parts
Hexanediol diacrylate: 0.60 parts

### (Aqueous Solution of Emulsifier)

20% aqueous DBS solution: 1.0 parts
Desalted water: 66.7 parts

### (Aqueous Solution of Initiator)

8% aqueous hydrogen peroxide solution: 15.5 parts
8% aqueous L-(+) ascorbic acid solution: 30.1 parts (Aqueous Solution of Iron Sulfate)
0.5% aqueous solution of iron (II) sulfate heptahydrate: 0.08 parts

After the polymerization reaction had been finished, cooling was performed. Hereby, a milky white styrene acrylic dispersion liquid A6 was prepared. The median diameter (D50) of the polymer primary particles determined using Nanotrac was 222 nm. The mass-average molecular weight (Mw) of the polymer primary particles was 80201.

### <Styrene Acrylic Dispersion Liquid A7>

Into a reaction container equipped with a stirring device, a heating/cooling device, a concentrating device, and devices for charging raw materials and agents, 34.8 parts of the wax dispersion liquid W5, 258 parts of desalted water, and 0.02 parts of a 0.5% aqueous solution of iron (II) sulfate heptahydrate were charged. While the resulting mixture was stirred, the temperature was increased in a nitrogen stream such that the internal temperature reached 70° C.

Subsequently, while stirring was continued, a mixture of the following monomers and emulsifier solutions was added to the mixture over 300 minutes to prepare an aqueous solution of monomers and emulsifiers. In this step, the time at which the addition of the mixture was started was considered as the time at which polymerization was started, and the following aqueous solutions of initiators were added dropwise to the mixture for 420 minutes after a lapse of 30 minutes since the start of polymerization. Subsequently, after a lapse of 300 minutes since the start of polymerization, the temperature was increased such that the internal temperature reached 90° C. After a lapse of 330 minutes since the start of polymerization, the following aqueous solution of iron sulfate was added to the mixture. The heating and stirring were continued for 540 minutes since the start of polymerization.

### (Monomers)

Styrene: 76.8 parts
Butyl acrylate: 23.2 parts
Acrylic acid: 1.5 parts
Trichlorobromomethane: 1.0 parts
Hexanediol diacrylate: 0.60 parts

### (Aqueous Solution of Emulsifier)

20% aqueous DBS solution: 1.0 parts
Desalted water: 66.7 parts

### (Aqueous Solution of Initiator)

8% aqueous hydrogen peroxide solution: 15.5 parts
8% aqueous L-(+) ascorbic acid solution: 30.1 parts

### (Aqueous Solution of Iron Sulfate)

0.5% aqueous solution of iron (II) sulfate heptahydrate: 0.08 parts

After the polymerization reaction had been finished, cooling was performed. Hereby, a milky white styrene acrylic dispersion liquid A7 was prepared. The median diameter (D50) of the polymer primary particles determined using Nanotrac was 234 nm. The mass-average molecular weight (Mw) of the polymer primary particles was 75601.

### <Polyester Resin>

Amorphous polyester resins A, B, and C were produced in the following manner.

A polyvalent carboxylic acid component, a polyhydric alcohol component, and a polymerization catalyst were charged into a reactor equipped with a distillation column in the charging composition described in Table 1. Note that the amount of the polymerization catalyst is an amount (ppm) relative to the amount of the acid component.

Subsequently, while the rotational speed of the stirring impeller of the reactor was kept at 120 rpm, heating was started. Heating was performed such that the temperature inside the reaction system reached 265° C. An esterification reaction was conducted while the above temperature was kept. After the discharge of water from the reaction system by distillation had been stopped and the esterification reaction had been finished, the temperature inside the reaction system was reduced and kept at 240° C., and the pressure inside the reactor was reduced over about 40 minutes such that a degree of vacuum of 133 Pa was achieved. A polycondensation reaction was conducted while an alcohol component was discharged from the reaction system by distillation.

The viscosity of the reaction system was increased during the reaction. The degree of vacuum was increased with the increase in viscosity, and the condensation reaction was continued until the torque of the stirring impeller reaches a value that indicated the intended softening temperature. When the predetermined torque was confirmed, stirring was stopped, and the pressure inside the reaction system was increased to normal pressure. The reaction product was taken (ejected) from the reactor by increasing the pressure using nitrogen. Hereby, amorphous polyester resins were prepared.

The mass-average molecular weights (Mw) of amorphous polyester resins A and B were 26000 and 72960, respectively. Note that above the mass-average molecular weights (Mw) were determined using the above-described method.

The physical properties (glass transition temperature, softening temperature, and acid value) of the amorphous polyester resins A, B, and C were measured. Table 1 lists the results.

In Table 1, the expressions “BPA-PO2.3 mol adduct” and “BPA-EO2.3 mol adduct” mean the following.

BPA-PO2.3 mol adduct: propylene oxide derivative of bisphenol A (polyoxypropylene-(2.3)-2,2-bis(4-hydroxyphenyl) propane (2.3-mole PO adduct))

BPA-E02.3 mol adduct: ethylene oxide derivative of bisphenol A (polyoxyethylene-(2.3)-2,2-bis(4-hydroxyphenyl) propane, (2.3-mole EO adduct))

TABLE 1

| | | Polyester resin | | |
|---|---|---|---|---|
| | | A | B | C |
| Polyvalent carboxylic | Terephthalic acid | 38 | 81 | 99.9 |
| acid component | Isophthalic acid | 35 | 1 | — |
| (molar part) | Trimellitic anhydride | 27 | 18 | — |
| | adipic acid | — | — | 0.1 |
| Polyhydric alcohol | BPA-PO2.3 mol adduct | 100 | 65 | 70 |
| component | BPA-EO2.3 mol adduct | — | 20 | — |
| (molar part) | Ethylene glycol | 37 | 46 | 32 |
| | Trimethylolpropane | — | — | 4 |
| Polymerization | Diantimony trioxide | 1500 | 1500 | — |
| catalyst (ppm) | Tetrabutyl titanate | — | — | 500 |
| Physical property | Glass transition | 57 | 62 | 66 |
| | temperature (° C.) | | | |
| | Softening temperature | 110 | 122 | 116 |
| | (° C.) | | | |
| | Acid value (mgKOH/g) | 12 | 5 | 11 |

### <Polyester Dispersion Liquid P1>

In 75 parts of methyl ethyl ketone (MEK), 25 parts of the amorphous polyester resin A was dissolved. To the resulting solution, 22.7 g of 5% aqueous ammonia solution was added. The resulting mixture was stirred homogeneously with a stirrer to form a resin solution.

Subsequently, 100 parts of desalted water was charged into a round-bottom flask. After the above resin solution had been further added to the flask, dispersion was performed with a homogenizer (Model: T25 produced by IKA) for 10 minutes at a rotational speed of 8000 rpm.

Then, distillation was performed using an aspirator at 80° C. under reduced pressure in order to remove the solvent. Hereby, a polyester dispersion liquid P1 was prepared. The median diameter (D50) of the polymer primary particles of the polyester resin particles included in the polyester dispersion liquid P1 determined using Nanotrac was 180 nm.

The storage moduli (G′) of the amorphous polyester resin A were G′ (70° C.)=31750000 Pa and G′ (100° C.)=5317 Pa. Note that the storage moduli (G′ (70° C.) and G′ (100° C.)) were measured using the above-described method.

### <Polyester Dispersion Liquid P2>

In 75 parts of methyl ethyl ketone (MEK), 25 parts of the amorphous polyester resin B was dissolved. To the resulting solution, 9.46 g of 5% aqueous ammonia solution was added. The resulting mixture was stirred homogeneously with a stirrer to form a resin solution.

Subsequently, 100 parts of desalted water was charged into a round-bottom flask. After the above resin solution had been further added to the flask, dispersion was performed with a homogenizer (Model: T25 produced by IKA) for 10 minutes at a rotational speed of 8000 rpm.

Then, distillation was performed using an aspirator at 80° C. under reduced pressure in order to remove the solvent. Hereby, a polyester dispersion liquid P2 was prepared. The median diameter (D50) of the polymer primary particles of the polyester resin particles included in the polyester dispersion liquid P2 determined using Nanotrac was 230 nm.

The storage moduli (G′) of the amorphous polyester resin B were G′ (70° C.)=25170870 Pa and G′ (100° C.)=25814 Pa. Note that the storage moduli (G′ (70° C.) and G′ (100° C.)) were measured using the above-described method.

### <Polyester Dispersion Liquid P3>

In 75 parts of methyl ethyl ketone (MEK), 25 parts of the amorphous polyester resin C was dissolved. To the resulting solution, 20.8 g of 5% aqueous ammonia solution was added. The resulting mixture was stirred homogeneously with a stirrer to form a resin solution.

Subsequently, 100 parts of desalted water was charged into a round-bottom flask. After the above resin solution had been further added to the flask, dispersion was performed with a homogenizer (Model: T25 produced by IKA) for 10 minutes at a rotational speed of 8000 rpm.

Then, distillation was performed using an aspirator at 80° C. under reduced pressure in order to remove the solvent. Hereby, a polyester dispersion liquid P3 was prepared. The median diameter (D50) of the polymer primary particles of the polyester resin particles included in the polyester dispersion liquid P3 determined using Nanotrac was 200 nm.

The storage moduli (G′) of the amorphous polyester resin C were G′ (70° C.)=5540400 Pa and G′ (100° C.)=167544 Pa. Note that the storage moduli (G′ (70° C.) and G′ (100° C.)) were measured using the above-described method.

### Example 1

A toner C1 was prepared in the following manner.

To a mixer equipped with a stirring device, a heating/cooling device, and devices for charging raw materials and agents, 85.0 parts (solid content) of the styrene acrylic dispersion liquid A1, 0.17 parts (solid content) of a 20% aqueous DBS solution, 0.56 parts (solid content) of a 5% aqueous solution of iron (II) sulfate heptahydrate, and 4.4 parts (solid content) of the coloring agent dispersion liquid G1 were added in order while being stirred. The internal temperature was increased to 41.0° C. over 60 minutes and subsequently increased to 45.0° C. over 180 minutes.

Subsequently, a liquid mixture of 15.0 parts (solid content) of the polyester dispersion liquid P1 and 0.3 parts (solid content (2 parts relative to 100 parts of polyester)) of a 20% aqueous DBS solution was added dropwise to the mixer over 30 minutes. After a lapse of 30 minutes since the addition was finished, the pH of the inside of the system was adjusted to 8.0 using a 4.8% aqueous solution of potassium hydroxide. Then, 6.0 parts (solid content) of a 20% aqueous DBS solution and 232.4 parts of deionized water were added. Subsequently, the temperature was increased to 75° C. over 90 minutes and then to 80° C. over 60 minutes. Subsequently, the temperature was reduced to 30° C. over 30 minutes.

The resulting dispersion liquid was taken and subjected to suction filtration using an aspirator through a filter paper “No. 5C” produced by Toyo Roshi Kaisha, Ltd. The cake that remained on the filter paper was transferred into a stainless steel container equipped with a stirrer (propeller blade). Ion-exchange water having an electric conductivity of 1 μS/cm was added to the container, and the resulting mixture was stirred to form a homogeneous dispersion. Stirring was continued for 30 minutes. The above step was repeated until the electric conductivity of the filtrate reached 2 μS/cm. Subsequently, the resulting cake was dried in a fan drying machine set at 40° C. for 48 hours. Hereby, base toner particles B1 were prepared.

To the base toner particles B1 (100 parts) prepared in the above-described manner, 4 parts of polymer/silica composite particles “ATLAS100” (produced by Cabot Corporation, silica/polymer ratio: 70/30, absolute specific gravity: 1.7 g/cm³, including octahydropentalene), 0.5 parts of titania/silica composite oxide particles “STX50.1” (produced by Nippon Aerosil Co., Ltd.), and 0.4 parts of small-diameter silica “RY200L” (produced by Nippon Aerosil Co., Ltd.) were added. The resulting mixture was stirred with a Henschel mixer at 3000 rpm for 15 minutes and subsequently screened. Hereby, a toner C1 was prepared.

The core-shell structure of the toner C1 was as described in Table 3.

The volume-median particle size, average circularity, and the percentage of particles of 1.0 μm or less by number of the toner C1 were determined. Table 2 lists the results.

### Example 2

A toner C2 was prepared as in the preparation of the toner C1, except that the styrene acrylic dispersion liquid A1 used in Example 1 was changed to the styrene acrylic dispersion liquid A2.

The core-shell structure of the toner C2 was as described in Table 3.

The volume-median particle size, average circularity, and the percentage of particles of 1.0 μm or less by number of the toner C2 were determined. Table 2 lists the results.

### Example 3

A toner C3 was prepared as in the preparation of the toner C1, except that, in Example 1, 95.0 parts (solid content) of the styrene acrylic dispersion liquid A1 and 5.0 parts (solid content) of the polyester dispersion liquid P1 were used.

The core-shell structure of the toner C3 was as described in Table 3.

The volume-median particle size, average circularity, and the percentage of particles of 1.0 μm or less by number of the toner C3 were determined. Table 2 lists the results.

### Example 4

A toner C4 was prepared as in the preparation of the toner C1, except that the styrene acrylic dispersion liquid A1 used in Example 1 was changed to the styrene acrylic dispersion liquid A3.

The core-shell structure of the toner C4 was as described in Table 3.

The volume-median particle size, average circularity, and the percentage of particles of 1.0 μm or less by number of the toner C4 were determined. Table 2 lists the results.

### Example 5

A toner C5 was prepared as in the preparation of the toner C1, except that the styrene acrylic dispersion liquid A1 used in Example 1 was changed to the styrene acrylic dispersion liquid A4.

The core-shell structure of the toner C5 was as described in Table 3.

The volume-median particle size, average circularity, and the percentage of particles of 1.0 μm or less by number of the toner C5 were determined. Table 2 lists the results.

### Example 6

A toner C6 was prepared as in the preparation of the toner C1, except that the styrene acrylic dispersion liquid A1 used in Example 1 was changed to the styrene acrylic dispersion liquid A5.

The core-shell structure of the toner C6 was as described in Table 3.

The volume-median particle size, average circularity, and the percentage of particles of 1.0 μm or less by number of the toner C6 were determined. Table 2 lists the results.

### Example 7

A toner C7 was prepared as in the preparation of the toner C1, except that the styrene acrylic dispersion liquid A1 used in Example 1 was changed to 97.0 parts (solid content) of the styrene acrylic dispersion liquid A5 and 3.0 parts (solid content) of the polyester dispersion liquid P1 was used.

The core-shell structure of the toner C7 was as described in Table 3.

The volume-median particle size, average circularity, and the percentage of particles of 1.0 μm or less by number of the toner C7 were determined. Table 2 lists the results.

### Example 8

A toner C8 was prepared as in the preparation of the toner C1, except that the styrene acrylic dispersion liquid A1 used in Example 1 was changed to 70.0 parts (solid content) of the styrene acrylic dispersion liquid A5 and 30.0 parts (solid content) of the polyester dispersion liquid P1 was used.

The core-shell structure of the toner C8 was as described in Table 3.

The volume-median particle size, average circularity, and the percentage of particles of 1.0 μm or less by number of the toner C8 were determined. Table 2 lists the results.

### Example 9

A toner C9 was prepared as in the preparation of the toner C1, except that the styrene acrylic dispersion liquid A1 used in Example 1 was changed to the styrene acrylic dispersion liquid A5 and the polyester dispersion liquid P1 used in Example 1 was changed to the polyester dispersion liquid P2.

The core-shell structure of the toner C9 was as described in Table 3.

The volume-median particle size, average circularity, and the percentage of particles of 1.0 μm or less by number of the toner C9 were determined. Table 2 lists the results.

### Example 10

A toner C10 was prepared as in the preparation of the toner C1, except that the styrene acrylic dispersion liquid A1 used in Example 1 was changed to the styrene acrylic dispersion liquid A6.

The core-shell structure of the toner C10 was as described in Table 3.

The volume-median particle size, average circularity, and the percentage of particles of 1.0 μm or less by number of the toner C10 were determined. Table 2 lists the results.

### Comparative Example 1

A toner C11 was prepared in the following manner.

To a mixer equipped with a stirring device, a heating/cooling device, and devices for charging raw materials and agents, 85.0 parts (solid content) of the styrene acrylic dispersion liquid A5, 0.17 parts (solid content) of a 20% aqueous DBS solution, 0.56 parts (solid content) of a 5% aqueous solution of iron (II) sulfate heptahydrate, and 4.4 parts (solid content) of the coloring agent dispersion liquid G1 were added in order while being stirred. The internal temperature was increased to 41.0° C. over 60 minutes and subsequently increased to 45.0° C. over 180 minutes.

Subsequently, 15.0 parts (solid content) of the styrene acrylic dispersion liquid A7 was added dropwise to the mixer over 30 minutes. After a lapse of 30 minutes, 4.0 parts (solid content) of a 20% aqueous DBS solution and 23 parts of deionized water were added. Subsequently, the temperature was increased to 80° C. over 90 minutes and then to 83° C. over 60 minutes. Subsequently, the temperature was reduced to 30° C. over 30 minutes.

The resulting dispersion liquid was taken and subjected to suction filtration using an aspirator through a filter paper “No. 5C” produced by Toyo Roshi Kaisha, Ltd. The cake that remained on the filter paper was transferred into a stainless steel container equipped with a stirrer (propeller blade). Ion-exchange water having an electric conductivity of 1 μS/cm was added to the container, and the resulting mixture was stirred to form a homogeneous dispersion. Stirring was continued for 30 minutes. The above step was repeated until the electric conductivity of the filtrate reached 2 μS/cm. Subsequently, the resulting cake was dried in a fan drying machine set at 40° C. for 48 hours. Hereby, base toner particles B11 were prepared.

To the base toner particles B11 (100 parts) prepared in the above-described manner, 4 parts of polymer/silica composite particles “ATLAS100” (produced by Cabot Corporation, silica/polymer ratio: 70/30, absolute specific gravity: 1.7 g/cm³, including octahydropentalene), 0.5 parts of titania/silica composite oxide particles “STX50.1” (produced by Nippon Aerosil Co., Ltd.), and 0.4 parts of small-diameter silica “RY200L” (produced by Nippon Aerosil Co., Ltd.) were added. The resulting mixture was stirred with a Henschel mixer at 3000 rpm for 15 minutes and subsequently screened. Hereby, a toner C11 was prepared.

The core-shell structure of the toner C11 was as described in Table 3.

The volume-median particle size, average circularity, and the percentage of particles of 1.0 μm or less by number of the toner C11 were determined. Table 2 lists the results.

### Comparative Example 2

A toner C12 was prepared as in the preparation of the toner C1, except that the styrene acrylic dispersion liquid A1 used in Example 1 was changed to 99.0 parts (solid content) of the styrene acrylic dispersion liquid A5 and 1.0 parts (solid content) of the polyester dispersion liquid P1 was used.

The core-shell structure of the toner C12 was as described in Table 3.

The volume-median particle size, average circularity, and the percentage of particles of 1.0 μm or less by number of the toner C12 were determined. Table 2 lists the results.

### Comparative Example 3

A toner C13 was prepared as in the preparation of the toner C1, except that the styrene acrylic dispersion liquid A1 used in Example 1 was changed to the styrene acrylic dispersion liquid A5 and the polyester dispersion liquid P1 used in Example 1 was changed to 15.0 parts (solid content) of the polyester dispersion liquid P3.

The core-shell structure of the toner C13 was as described in Table 3.

The volume-median particle size, average circularity, and the percentage of particles of 1.0 μm or less by number of the toner C13 were determined. Table 2 lists the results.

TABLE 2

| | | | | Percentage of |
|---|---|---|---|---|
| | | Volume-median | Average | particles of 1.0 μm |
| | Toner | size (μm) | circularity | or less by number |
| Example 1 | C1 | 5.68 | 0.961 | 0.09 |
| Example 2 | C2 | 5.59 | 0.960 | 0.13 |
| Example 3 | C3 | 5.70 | 0.960 | 0.21 |
| Example 4 | C4 | 5.69 | 0.959 | 0.15 |
| Example 5 | C5 | 5.51 | 0.962 | 0.16 |
| Example 6 | C6 | 5.56 | 0.961 | 0.08 |
| Example 7 | C7 | 5.50 | 0.960 | 0.15 |
| Example 8 | C8 | 5.89 | 0.958 | 0.19 |
| Example 9 | C9 | 5.80 | 0.961 | 0.21 |
| Example 10 | C10 | 5.56 | 0.961 | 0.09 |
| Comparative | C11 | 5.68 | 0.961 | 0.16 |
| Example 1 | | | | |
| Comparative | C12 | 5.59 | 0.960 | 0.11 |
| Example 2 | | | | |
| Comparative | C13 | 5.65 | 0.960 | 0.13 |
| Example 3 | | | | |

### <Steps for Cross-Sectional SEM Observation of Fixed Image and Calculation of Ratio (A/B) of Length of Polyester Resin Particles in Contact With Fixed Surface>

The toner was fixed onto the surface of a printing medium (PET coated paper) at a density of 0.8 mg/cm² under the same printing conditions as in <Scraping Test> below, and a cross section of the PET coated paper was observed with a backscattered electron detector of a scanning electron microscope (SEM) at a 10,000-fold magnification.

The above observation steps were repeated for different fields of view 40 times in total to obtain 40 observation images. For each of the images, the length of portions of the image in which the polyester resin included in the toner surface was in contact with the surface of the printing medium was measured, and the total (A) of the above lengths was calculated. Subsequently, the length of portions of the image in which the toner was in contact with the surface of the printing medium was measured, and the total (B) of the above lengths was calculated. The total (A) of the above lengths was divided by the total (B) to obtain the value (A/B). This value (A/B) was considered as the ratio of the length of polyester resin particles included in the toner surface which were in contact with the surface of the PET coated paper. Note that, in the measurement of the above length, when some of the toner particles were detached from the fixed surface in the observed cross section, they were considered as being in contact with the fixed surface.

The (A) and (B) were determined as described above. For example, as for the toner C1 prepared in Example 1, in FIG. 1, the portion denoted with the dotted line is the “portions in which the polyester resin included in the toner surface is in contact with the surface of the printing medium (PET coated paper sheet)”, and the total length of the portions denoted with the dotted line was the (A). In FIG. 1, the total length of the portion denoted with the broken line is the total length of the “portions in which the toner is in contact with the surface of the printing medium (PET coated paper sheet)”, that is, the (B).

Although detailed steps are described below, the methods and devices are not limited to those described below. It is possible to use a cross-section preparation method and a microscope observation method with which results appropriate to the object can be achieved.

An image fixed to a PET coated paper sheet was cut to a square with a side of a few millimeters. The thickness of the PET coated paper sheet was reduced by cutting the opposite surface (non-printing surface) with a razor such that the fixed image was not damaged. The thinned PET coated paper piece was bonded to a metal plate having a thickness of about 0.3 mm with an instant adhesive with the image-fixed surface facing upward.

The metal plate including the PET coated paper piece bonded thereto was fixed to a stage of “Cross Section Polisher SM-9010” produced by JEOL Ltd. so as to be irradiated with ion beams from the metal plate-side. A portion of the paper piece which extended off the metal plate was cut off such that the razor blade traveled from the fixed image-side to the metal plate-side.

The stage on which the metal plate was held was attached to the chamber of Cross Section Polisher, and machining was performed for 3 hours using an argon ion beam at an acceleration voltage of 4 kV and a current of about 100 μA.

The machined specimen was held on the SEM stage with the machined surface facing upward. The interface (contact surface) between the toner and the PET coated paper was observed in the machined surface with a backscattered electron detector at an acceleration voltage of 3 to 5 kV and an irradiation current of about 1 nA using JSM-F100 produced by JEOL Ltd. An image was taken in 40 fields of view at a 10,000-fold magnification.

For each of the images taken, the length of the portions in which the polyester resin included in the toner surface was in contact with the surface of the PET coated paper sheet was measured. The total of the lengths was defined as “A”. Using the same images, the length of the portions in which the toner was in contact with the surface of the PET coated paper sheet was measured, and the total of the above lengths was defined as “B”. The proportion of the length of the portions in which the polyester resin included in the toner surface was in contact with the surface of the PET coated paper sheet was calculated using the following formula. Table 4 lists the results.

(Proportion of length of portions in which polyester resin included in toner surface was in contact with surface of the PET coated paper sheet)=A/B

FIG. 1 is a cross-sectional SEM image of the fixed image prepared in Example 1 using the toner C1.

### <Calculation of Ratio (X/Y) of Calculated Coverage X to Measured Coverage Y of Toner Surface With Polyester Resin>

The calculated coverage X of the toner surface with the polyester resin was calculated using the above-described method. As the measured coverage Y, the A/B ratio was used in percentage terms. Table 5 lists the results.

### <Calculation of Average Thickness of Polyester Resin in Toner Surface>

The thickness of the polyester resin in the toner surface was directly measured in each of the images above. For each field of view (each image), the length of the thickest of the polyester resin portions that were in contact with the printing medium was measured, and the average thereof was calculated. The above operation was done for 40 fields of view (40 images). The overall average was used as the average thickness of the polyester resin in the toner surface. Table 5 lists the results.

### <DSC Measurement>

The DSC measurement of the toner was conducted by the following method.

The device used was “AAQ20” and a cooling device “RCS90” (both produced by TA Instruments).

The sample pan used was “TzeroStandard”, with which 3.0 mg of the sample was weighed.

The measurement was conducted as described below.

The temperature was adjusted to 20° C. As a first temperature rise, the temperature was increased to 120° C. at 10° C./min. After holding was performed at 120° C. for 5 minutes, the temperature was reduced to 0° C. at 10° C./min. After holding had been performed at 0° C. for 5 minutes, the temperature was increased to 120° C. at 10° C./min as a second temperature rise.

In the above DSC measurement, the difference between the half-width of the endothermic peak that occurs during the first temperature drop and the half-width of the exothermic peak that occurs during the first temperature rise [(First temperature drop)−(First temperature rise)] and the difference between the half-width of the endothermic peak that occurs during the first temperature drop and the half-width of the exothermic peak that occurs during the second temperature rise [(First temperature drop)−(Second temperature rise)] are listed in Table 4.

### <Adhesiveness Evaluation (Scraping Test)>

With the toner prepared above, an unfixed toner image having a deposition density of about 0.8 mg/cm² was formed on a gloss recording paper (waterproof paper “Careca”, produced by Kokusai Pulp & Paper Co., Ltd.), which is PET coated paper, using a commercial printer having a printing speed of 16 ppm, which included a non-magnetic single-component organic photosensitive member capable of being charged with a rubber developing roller, a metal blade, and a charging roller (PCR) and did not include a fusing unit, and two toner cartridges.

The thermal roller fuser used had a roller diameter of 27 mm, a nip width of 9 mm, and a fusing speed of 95 mm/sec. The upper roller was provided with a heater. The surface of the rollers was composed of PFA (tetrafluoroethylene-perfluoroalkyl vinyl ether copolymer). A silicone oil was not applied on the rollers.

The surface temperature of the rollers was set to 175° C. The recording paper sheet including the unfixed toner image having a deposition density of about 0.8 mg/cm² formed thereon was transported to the fusing nip portion in order to form a fixed image. The fixed image was scraped with a vertically arranged flathead screwdriver in order to conduct a scraping test. The width of the end of the flathead screwdriver had a width of 1 mm. A load of 250 g was applied to the end using a weight. In the scraping test, the travel distance was set to 2 cm and the screwdriver was travelled three times in total in a reciprocating manner. The travelling speed was about 1 cm/s. The angle formed by the travelling direction and the end surface of the flathead screwdriver was 90°. The degree of scraping was visually confirmed and evaluated in accordance with the following standard. Table 4 lists the evaluation results.

### (Evaluation Standard)

⊚: The image could not be scraped off at all.

o: One or less white spots were created as a result of scraping.

Δ: The length of a line created as a result of scraping was less than 3 mm, or a plurality of white spots were present.

x: The length of a line created as a result of scraping was 3 mm or more.

### <Evaluation of Low-Temperature Fixability>

With the toner prepared above, an unfixed toner image having a toner deposition density of about 0.5 mg/cm² was formed on a recording paper (“OKI Excellent White” (product name)) using a commercial printer having a printing speed of 16 ppm, which included a non-magnetic single-component organic photosensitive member capable of being charged with a rubber developing roller, a metal blade, and a charging roller (PCR) and did not include a fusing unit.

The thermal roller fuser used had a roller diameter of 27 mm and a nip width of 9 mm. The upper roller was provided with a heater. The surface of the rollers was composed of PFA (tetrafluoroethylene-perfluoroalkyl vinyl ether copolymer). A silicone oil was not applied on the rollers. The surface temperature of the rollers was set to 145° C., 150° C., or 155° C. Fusing was performed at any of the above temperatures and a fusing speed of 229 mm/sec to prepare evaluation samples. In the fusing test, the following evaluation standard was used. Table 4 lists the evaluation results.

### (Evaluation Standard)

o: The offset of the fixed image did not occur, and image defects did not occur even when the image was scratched.

Δ: The offset of the fixed image did not occur, but image defects occurred even when the image was scratched.

x: The offset of the fixed image occurred.

### <Evaluation of Storage Stability>

A metal cylinder having a diameter of 2 cm was placed on a metal flat plate in an upright position. A medicine wrapping paper sheet was wound around the inner periphery of the cylinder. Into the metal cylinder placed in an upright position, 10 g of the toner was calmly charged, and a weight of 20 g was subsequently placed on the toner.

While the metal cylinder was placed on the metal plate, they were placed in a thermo-hygrostat having a temperature of 50° C. and a relative humidity of 55% (normal humidity condition) and held for 48 hours or placed in a high-temperature, high-humidity machine at a temperature of 50° C. and a relative humidity of 80% (high-humidity condition) and held for 24 hours. After the sample had been taken from the thermo-hygrostat, the metal cylinder and the medicine wrapping paper sheet were calmly removed, and the toner adhered in a cylindrical shape was taken therefrom while kept in an upright position.

A load was applied to the adhered toner which was kept in an upright position in steps of 10 g, and the load at which the cylindrical shape became deformed was measured. An evaluation was made on the basis of the measured load in accordance with the following standard. Table 4 lists the evaluation results.

### (Evaluation Standard)

o: The shape became deformed at a load of 500 g or less. This means that the adhesion of the toner was weak and the toner had suitable storage stability.

Δ: The shape did not become deformed at a load of 500 g, but became deformed at a load of 1500 g or less.

x: The shape did not become deformed at a load of 1500 g. This means that the adhesion of the toner was strong and the toner had poor storage stability.

TABLE 3

| | Core | | | Shell | | | |
|---|---|---|---|---|---|---|---|
| | | Wax | | Binder resin | | | |
| | Binder | | Content in toner | | Tg | Acid value | Content in toner |
| | resin | Type | (mass %) | Type | (° C.) | (mgKOH/g) | (mass %) |
| Example 1 | StAc-A1 | Ester wax 1 | 7.4 | PES-A | 57 | 12 | 14.4 |
| Example 2 | StAc-A2 | Ester wax 1 | 13.6 | PES-A | 57 | 12 | 14.4 |
| Example 3 | StAc-A1 | Ester wax 1 | 15.2 | PES-A | 57 | 12 | 4.8 |
| Example 4 | StAc-A3 | Ester wax 2 | 13.6 | PES-A | 57 | 12 | 14.4 |
| Example 5 | StAc-A4 | Ester wax 3 | 13.6 | PES-A | 57 | 12 | 14.4 |
| Example 6 | StAc-A5 | Ester wax 4 | 7.4 | PES-A | 57 | 12 | 14.4 |
| Example 7 | StAc-A5 | Ester wax 4 | 8.5 | PES-A | 57 | 12 | 2.9 |
| Example 8 | StAc-A5 | Ester wax 4 | 6.1 | PES-A | 57 | 12 | 28.7 |
| Example 9 | StAc-A5 | Ester wax 4 | 7.4 | PES-B | 62 | 5 | 14.4 |
| Example 10 | StAc-A6 | Ester wax 1 | 3.7 | PES-A | 57 | 12 | 14.4 |
| | | Ester wax 4 | 3.7 | | | | |
| Comparative | StAc-A5 | Ester wax 4 | 7.4 | StAc-A7 | 62.5 | 11 | 14.4 |
| Example 1 | | | | | | | |
| Comparative | StAc-A5 | Ester wax 4 | 8.6 | PES-A | 57 | 12 | 1.0 |
| Example 2 | | | | | | | |
| Comparative | StAc-A5 | Ester wax 4 | 7.8 | PES-C | 66 | 11 | 9.6 |
| Example 3 | | | | | | | |

TABLE 4

| | | Half-width | | | | | | | |
|---|---|---|---|---|---|---|---|---|---|
| | | difference (° C.) | | Evaluation result | | | | | |
| | | (first | (first | | Low-temperature | | | | |
| | | temperature | temperature | | fixability | | | Storage stability | |
| | | drop) − (first | drop) − (second | Adhesiveness | Roller surface | | | Normal | High |
| | A/B | temperature | temperature | (Scraping | temperature | | | humidity | humidity |
| | ratio | rise) | rise) | test) | 145° C. | 150° C. | 155° C. | condition | condition |
| Example 1 | 0.33 | 0.90 | 1.15 | ⊚ | Δ | ◯ | ◯ | ◯ | ◯ |
| Example 2 | 0.30 | 0.91 | 1.10 | ⊚ | ◯ | ◯ | ◯ | ◯ | ◯ |
| Example 3 | 0.10 | 0.92 | 1.18 | ◯ | ◯ | ◯ | ◯ | ◯ | ◯ |
| Example 4 | 0.36 | 3.40 | 3.51 | ⊚ | ◯ | ◯ | ◯ | ◯ | ◯ |
| Example 5 | 0.29 | 3.28 | 3.62 | ⊚ | ◯ | ◯ | ◯ | Δ | Δ |
| Example 6 | 0.37 | 6.44 | 7.03 | ⊚ | Δ | Δ | ◯ | ◯ | ◯ |
| Example 7 | 0.06 | 6.49 | 7.06 | Δ | Δ | Δ | ◯ | Δ | Δ |
| Example 8 | 0.48 | 6.52 | 7.02 | ⊚ | Δ | Δ | ◯ | ◯ | Δ |
| Example 9 | 0.06 | 6.47 | 7.02 | Δ | Δ | Δ | ◯ | Δ | Δ |
| Example 10 | 0.35 | 1.90 | 2.14 | ⊚ | Δ | ◯ | ◯ | ◯ | ◯ |
| Comparative | 0.00 | 6.44 | 7.03 | X | X | Δ | Δ | ◯ | ◯ |
| Example 1 | | | | | | | | | |
| Comparative | 0.02 | 6.43 | 7.06 | X | Δ | Δ | ◯ | X | X |
| Example 2 | | | | | | | | | |
| Comparative | 0.00 | 6.49 | 7.08 | X | Δ | Δ | ◯ | X | X |
| Example 3 | | | | | | | | | |

TABLE 5

| | Coverage of toner surface with polyester resin | | | Average |
|---|---|---|---|---|
| | Calculated | Measured | | thickness |
| | value X (%) | value Y (%) | X/Y | (μm) |
| Example 1 | 120 | 33 | 3.64 | 0.319 |
| Example 2 | 118 | 30 | 3.93 | 0.298 |
| Example 3 | 36 | 10 | 3.60 | 0.284 |
| Example 4 | 121 | 36 | 3.36 | 0.322 |
| Example 5 | 117 | 29 | 4.03 | 0.335 |
| Example 6 | 118 | 37 | 3.19 | 0.301 |
| Example 7 | 21 | 6 | 3.39 | 0.278 |
| Example 8 | 300 | 48 | 6.25 | 0.539 |
| Example 9 | 96 | 6 | 16.00 | 0.661 |
| Example 10 | 118 | 35 | 3.37 | 0.309 |
| Comparative | 0 | 0 | — | — |
| Example 1 | | | | |
| Comparative | 7 | 2 | 3.50 | 0.306 |
| Example 2 | | | | |
| Comparative | 100 | 0 | — | — |
| Example 3 | | | | |

### DISCUSSIONS

Examples and Comparative Examples above confirm that, since the present toner includes an adequate amount of polyester resin arranged in the surfaces of the particles of the toner, the strength between the toner particles and a printing medium and the strength between the toner particles can be increased and, consequently, the present toner is excellent in terms of adhesiveness to printing media, such as PET coated paper, and low-temperature fixability. In addition, the storage stability of the present toner does not become degraded at high humidities.

Although the present invention has been described in detail by way of the specific modes, it is apparent for those skilled in the art that various changes can be made without departing from the spirit and scope of the present invention.

The present application is based on Japanese Patent Application No. 2022-055334 filed on Mar. 30, 2022, the entire contents of which are incorporated herein by reference.

1. A toner comprising at least a binder resin,
the binder resin including at least a polyester resin,
wherein a content of the polyester resin is 2.5% by mass or more of a total mass of the toner, and
when a total length of a portion of a cross section of a printed article produced by fixing the toner to a PET coated paper sheet under printing conditions including a printing temperature of 175° C., a printing speed of 16 ppm, and a printing density of 0.8 mg/cm², the portion in which the polyester resin is in contact with the PET coated paper sheet, is defined as A, and a total length of a portion of the cross section, the portion in which the toner is in contact with the PET coated paper sheet, is defined as B, A and B satisfy Formula (1) below.
$$0.05 \leq A / B \leq 0 \text{.55} \qquad ( 1 )$$

2. The toner according to claim 1, wherein the binder resin further includes a styrene acrylic resin.

3. The toner according to claim 1, wherein the polyester resin is an amorphous polyester resin.

4. The toner according to any one of claim 1, wherein the content of the polyester resin is 2.5% by mass or more and 40% by mass or less of the total mass of the toner.

5. The toner according to any one of claim 1, further comprising a wax.

6. The toner according to claim 5, wherein a content of the wax is 5% by mass or more and 30% by mass or less of the total mass of the toner.

7. The toner according to claim 5, wherein the wax is a crystalline wax.

8. The toner according to claim 7, wherein, in differential scanning calorimetry (DSC) that implements a temperature program including increasing temperature from 40° C. to 100° C. or more at a heating rate of 10° C./min (first temperature rise), subsequently reducing temperature to 40° C. or less at a cooling rate of 10° C./min (first temperature drop), and then increasing temperature to 100° C. or more at a heating rate of 10° C./min (second temperature rise), a difference between a half-width of an endothermic peak that occurs during the first temperature drop and a half-width of an exothermic peak that occurs during the first temperature rise [(first temperature drop)−(first temperature rise)] is 7.0° C. or less, and a difference between the half-width of the endothermic peak that occurs during the first temperature drop and a half-width of an exothermic peak that occurs during the second temperature rise [(first temperature drop)−(second temperature rise)] is 7.0° C. or less.

9. The toner according to any one of claim 1, wherein the polyester resin has an acid value of 5 mgKOH/g or more.

10. The toner according to any one of claim 1, wherein the polyester resin has a glass transition temperature (Tg) of 50° C. or more and 70° C. or less.

11. The toner according to any one of claim 1, the toner having a structure constituted by a core and a shell, wherein a binder resin included in the core is the styrene acrylic resin, and a binder resin included in the shell is the polyester resin.

12. The toner according to any one of claim 1, the toner having a volume-median particle size of 6.5 μm or less, wherein a proportion of particles having a primary particle size of 1.0 μm or less is 3.0% or less by number.

13. The toner according to any one of claim 1, further comprising a coloring agent.

14. A toner cartridge comprising the toner according to claim 1.

15. An image forming apparatus comprising the toner according to claim 1.

16. A printed article comprising a printing medium and a toner fixed on the printing medium,
the toner being a toner including at least a binder resin,
the binder resin including at least a polyester resin,
wherein a content of the polyester resin is 2.5% by mass or more of a total mass of the toner, and
when a total length of a portion of a cross section of a printed article produced by fixing the toner to a PET coated paper sheet under printing conditions including a printing temperature of 175° C., a printing speed of 16 ppm, and a printing density of 0.8 mg/cm², the portion in which the polyester resin is in contact with the PET coated paper sheet, is defined as A, and a total length of a portion of the cross section, the portion in which the toner is in contact with the PET coated paper sheet, is defined as B, A and B satisfy Formula (1) below.
$$0.05 \leq A / B \leq 0 \text{.55} \qquad ( 1 )$$

17. The printed article according to claim 16, wherein the binder resin further includes a styrene acrylic resin.
